(19) United States
(12) Patent Application Publication
(10) Pub. No.: US 2025/0104957 A1
(43) Pub. Date: Mar. 27, 2025

(54) CATHODE ASSEMBLIES, METHODS FOR ADJUSTING FOCAL POINTS OF X-RAYS, AND METHODS FOR CONTROLLING FOCUSED ELECTRON BEAMS

(71) Applicant: WUHAN UNITED IMAGING HEALTHCARE CO., LTD., Wuhan (CN)

(72) Inventors: Heng TANG, Wuhan (CN); Jiajia TIAN, Shanghai (CN)

(73) Assignee: WUHAN UNITED IMAGING HEALTHCARE CO., LTD., Wuhan (CN)

(21) Appl. No.: 18/895,360

(22) Filed: Sep. 24, 2024

(30) Foreign Application Priority Data
Sep. 25, 2023 (CN) 202311246000.5
Sep. 25, 2023 (CN) 202311253878.1

(51) Int. Cl. H01J 35/06; H01J 35/14; H05G 1/32; H05G 1/52

(52) U.S. Cl. CPC H01J 35/064; H01J 35/147; H01J 35/153; H05G 1/32; H05G 1/52

(57) ABSTRACT

Embodiments of the present disclosure provide a cathode assembly (200), which may include a cathode (210) and a focusing electrode (220). The cathode (210) may include at least two emission portions each of which may be configured to independently emit an electron beam, and the at least two emission portions may be arranged around a center of the cathode. The focusing electrode may be arranged around a periphery of the cathode, and a first surface of the focusing electrode may form a first acute angle (250) with an axial direction passing through the center of the cathode.

### CROSS-REFERENCE TO RELATED APPLICATIONS

This application claims priority to Chinese Patent Application No. 202311253878.1, filed on Sep. 25, 2023, and Chinese Patent Application No. 202311246000.5, filed on Sep. 25, 2023, the entire contents of each of which are incorporated herein by reference.

### TECHNICAL FIELD

The present disclosure relates to the field of of X-ray technology, and in particular relates to a cathode assembly, a method for adjusting a focal point of an X-ray, and a method for controlling a focused electron beam.

### BACKGROUND

X-ray technology is widely utilized in life, for example, X-rays are widely used in industrial non-destructive testing, safety inspections, and medical diagnosis and treatment. In particular, X-ray fluoroscopic imaging equipment made by utilizing the high penetrating ability of X-rays plays an important role in all aspects of people's daily lives. Computed tomography (CT) equipment, for example, is advanced for high-end applications as it can obtain high-definition three-dimensional stereo graphic or slice images. A cathode structure is an important component in the X-ray equipment. However, the existing cathode structure is not only complicated in structure, but also not flexible enough for adjusting a size of a focal point of an X-ray electron beam.

Therefore, embodiments of the present disclosure provide a cathode assembly, a method for adjusting a focal point of an X-ray, and a method for controlling a focused electron beam, which enable flexible changes in the focal point of the electron beam.

### SUMMARY

One of the embodiments of the present disclosure provides a cathode assembly, which may include a cathode and a focusing electrode. The cathode may include at least two emission portions each of which being configured to independently emit an electron beam, and the at least two emission portions may be arranged around a center of the cathode. The focusing electrode may be arranged around a periphery of the cathode, wherein a first surface of the focusing electrode may form a first acute angle with an axial direction passing through the center of the cathode.

One of the embodiments of the present disclosure provides a method for adjusting a focal point of an X-ray using a cathode assembly. The method may include: obtaining an operating mode of an X-ray tube; applying a preset current to the cathode according to the operating mode, to selectively control one or more of the at least two emission portions of the cathode to emit the electron beams.

One of the embodiments of the present disclosure provides a method for controlling a focused electron beam using a cathode assembly. The method may include: determining at least one target emission portion of the cathode according to a desired position and a desired size of a target focal point; providing a first potential to the at least one target emission portion; and providing a second potential to the focusing electrode, so as to focus the electron beam emitted from the at least one target emission portion.

The cathode assembly provided in the embodiments of the present disclosure includes a cathode and a focusing electrode, the cathode includes a plurality of emission portions each of which independently emitting an electron beam, the plurality of emission portions being arranged in a circumferential direction around the center of the cathode. The focusing electrode may be arranged around the periphery of the cathode, and a first surface of the focusing electrode forming a first acute angle with an axial direction passing through the center of the cathode. The focusing electrode may be configured to focus the electron beams emitted by the plurality of emission portions. The cathode in the present disclosure includes a plurality of emission portions that may emit electron beams independently, and by emitting electron beams independently through the emission portions, a beam spot of a certain size may be formed on an anode. When it is necessary to adjust a size of the beam spot, a size of the electron beam emitted by the cathode may be adjusted by adjusting a count of emission portions that emit electron beams or reconfirming the emission portions that emit the electron beams, so as to adjust a size of a focal spot. In addition, a magnitude of a tube current may be be switched in real-time by adjusting the count of the emission portions emitting the electron beams or by varying a magnitude of a current drawn from each emission portion. Compared to the prior art, which requires adjustment of a cathode temperature and is limited by a performance of a focusing device to modify the size of the focal point, the present disclosure provides high flexibility in real-time switching of the electron beam spot size and current magnitude.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram of an exemplary X-ray tube according to some embodiments of the present disclosure;

FIG. 2 is a schematic diagram of an exemplary cathode assembly according to some embodiments of the present disclosure;

FIG. 3 is a schematic diagram of an exemplary cathode according to some embodiments of the present disclosure;

FIG. 4 is a cross-sectional view of an exemplary cathode assembly according to some embodiments of the present disclosure;

FIG. 5 is a schematic diagram of exemplary cathodes with different shapes according to some embodiments of the present disclosure;

FIG. 6 is an exemplary schematic diagram illustrating a count of cathode sheets of a cathode according to some embodiments of the present disclosure;

FIG. 7 is a schematic diagram of an exemplary cathode assembly comprising a fitting hole according to some embodiments of the present disclosure;

FIG. 8 is a schematic diagram of an exemplary fitting hole according to some embodiments of the present disclosure;

FIG. 9 is a schematic diagram of an exemplary fitting hole and an exemplary auxiliary electrode according to some embodiments of the present disclosure;

FIG. 10 is a cross-sectional view of an exemplary cathode assembly comprising a fitting hole according to some embodiments of the present disclosure;

FIG. 11 is a schematic diagram of an exemplary focusing electrode of a cathode assembly according to some embodiments of the present disclosure;

FIG. 12 is a schematic diagram of an exemplary rectangular focusing electrode according to some embodiments of the present disclosure;

FIG. 13 is a schematic diagram of an exemplary cathode assembly according to some embodiments of the present disclosure;

FIG. 14 is a cross-sectional view of an exemplary cathode assembly comprising an auxiliary electrode according to some embodiments of the present disclosure;

FIG. 15a is a schematic diagram of an exemplary spherical-like cathode according to some embodiments of the present disclosure;

FIG. 15b is a schematic diagram of another exemplary spherical-like cathode according to some other embodiments of the present disclosure;

FIG. 16 is a schematic diagram of an exemplary cathode assembly comprising a cathode with a spherical-like according to some embodiments of the present disclosure;

FIG. 17 is a cross-section of the cathode assembly shown in FIG. 16 of the present disclosure;

FIG. 18 is a schematic diagram of an exemplary cathode assembly including an auxiliary electrode according to some other embodiments of the present disclosure;

FIG. 19 is a schematic diagram of an exemplary cathode including an exemplary auxiliary electrode according to some embodiments of the present disclosure;

FIG. 20 is an exemplary cross-sectional view of a cathode assembly and an auxiliary electrode according to some embodiments of the present disclosure;

FIG. 21 is an exemplary cross-sectional view of a cathode assembly according to some embodiments of the present disclosure;

FIG. 22 is a schematic diagram of an exemplary installation region of a cathode according to some embodiments of the present disclosure;

FIG. 23 is a schematic diagram of an exemplary beam spot distribution of a cathode assembly in a first operating mode according to some embodiments of the present disclosure;

FIG. 24 is a schematic diagram of an exemplary beam spot distribution of a cathode assembly in a second operating mode according to some embodiments of the present disclosure;

FIG. 25 is a schematic diagram of an exemplary beam spot distribution of a cathode assembly in a third operating mode according to some embodiments of the present disclosure;

FIG. 26 is a schematic diagram of an exemplary beam spot distribution of a cathode assembly in a fourth operating mode according to some embodiments of the present disclosure;

FIG. 27 is a flowchart of an exemplary process for adjusting a focal point of an X-ray according to some embodiments of the present disclosure;

FIG. 28 is a flowchart of an exemplary process for controlling a focused electron beam according to some embodiments of the present disclosure;

FIG. 29 is a flowchart of an exemplary process for supplying a third potential to an auxiliary electrode according to some embodiments of the present disclosure;

FIG. 30 is a flowchart of an exemplary process for supplying a third potential to an auxiliary electrode according to some embodiments of the present disclosure;

FIG. 31 is a flowchart of an exemplary process for correcting an abnormal transmission portion according to some embodiments of the present disclosure;

FIG. 32 is a schematic diagram of exemplary modules of a system for adjusting a focal point of an X-ray according to some embodiments of the present disclosure; and

FIG. 33 is a schematic diagram of exemplary modules of a system for controlling a focused electron beam according to some embodiments of the present disclosure.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, the operations may be executed in reverse order or simultaneously. Additionally, one or more other operations may be added to these processes, or one or more operations may be removed from these processes.

Currently, X-ray Computed Tomography (CT) is widely used in medical diagnosis and other fields. CT scanning equipment emits an electron beam by heating a cathode of a bulb tube. However, in a process of emitting the electron beam from the cathode, a relatively high power corresponds to a relatively high cathode temperature, which affects a service life of the cathode. In addition, in some scanning scenarios, an adjustment of a size and a position of a focal point of an X-ray may be required. However, the existing cathode structure may not satisfy the need for adjusting the size and the position of the focal point. Therefore, the existing cathode structure is not flexible enough for complex imaging applications. For example, a tube current of an X-ray tube may be adjusted only by changing the cathode temperature. However, due to a thermal inertia of the cathode, the tube current may not be switched in real time. As another example, for the adjustment of the position of the focal point, a conventional X-ray tube often uses an electrical focusing structure that introduces a nonlinear force. The nonlinear force may degrade a laminar flow of the electron beam, resulting in poor uniformity of an electron beam spot on a target disk, which in turn reduces a power of the X-ray tube and shortens a service life of the target disk. Furthermore, in order to enhance a capability of the X-ray tube for adjusting the focal point, existing technologies often incorporate multiple focusing elements, which increases both a cost and a size of the X-ray tube.

In view of the foregoing, some embodiments of the present disclosure disclose a cathode assembly, a method for adjusting a focal point of an X-ray, and a method for controlling a focused electron beam, which not only achieve various focal point size adjustment functions while maintaining the compactness and uniformity of the X-ray tube, but also improve the safety, accuracy, reliability, and stability of X-ray diagnostics. The technical solutions disclosed herein are described below with reference to the accompanying drawings.

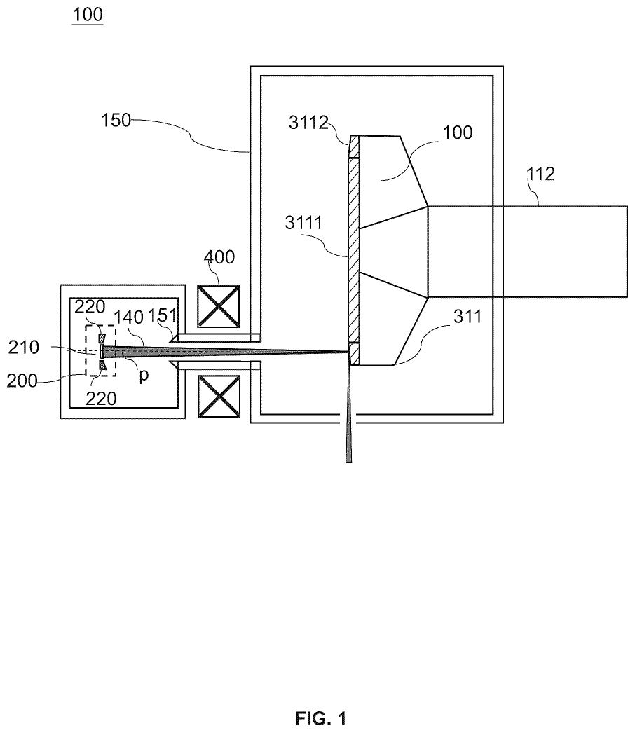

FIG. 1 is a schematic diagram of an exemplary X-ray tube according to some embodiments of the present disclosure.

As shown in FIG. 1, an X-ray tube 100 includes a cathode assembly 200, an anode assembly 300, and a focusing deflection structure 400. The anode assembly 300 and the cathode assembly 200 may be spaced apart along an emission direction of an electron beam 140, and the focusing deflection structure 400 may be provided between the anode assembly 300 and the cathode assembly 200.

The cathode assembly 200 may include a cathode 210 and a focusing electrode 220. The cathode 210 may include at least two emission portions (not shown in FIG. 1) each of which may be configured to independently emit an electron beam. Each of the at least two emission portions may include at least one cathode sheet. A plurality of cathode sheets of the at least two emission portions may be arranged along a circumferential direction around a center of the cathode 210. The plurality of cathode sheets may be set at an acute angle to a central axis p of the cathode 210. Each of the plurality of cathode sheets may be configured to independently emit the electron beam 140. The focusing electrode 220 may be arranged around a periphery of the cathode 210. The focusing electrode 220 may have a focusing surface, and the focusing surface may form an acute angle with the center axis p of the cathode 210. The focusing electrode 220 may be configured to focus the electron beams 140 emitted by the cathode 210.

The focusing deflection structure 400 may be configured to cooperate with the focusing electrode 220 to focus the electron beams 140 emitted by the cathode 210 onto the anode assembly 300. In some embodiments, the focusing deflection structure 400 in cooperation with the focusing electrode 220 enables focusing the electron beams 140 emitted by the at least two emission portions such that a change in a potential of the focusing electrode 320 does not affect the focusing of the electron beams 140 on the anode assembly 300, thereby improving an adjustment range of the potential of the focusing electrode 320, and improving a reliability and an adaptability of the X-ray tube.

In some embodiments, the focusing deflection structure 400 may be formed by an electric field or a magnetic field. If the focusing deflection structure 400 is a magnetic field structure, the focusing deflection structure 400 may include a quadrupole magnet for further shaping of a beam spot, and the focusing deflection structure 400 may further include a guiding magnet for focus deflection of the beam spot. If the focusing deflection structure 400 is an electric field structure, the focusing of the beam spot may be accomplished by designing a metal structure with a certain shape and voltage distribution. By independently controlling current emissions of four arc-shaped cathodes and combining different counts of the arc-shaped cathodes, it is possible to achieve switching between at least four different focal spot size with the assistance of a single quadrupole magnet.

In some embodiments, the anode assembly 300 may include a target disk 311. The target disk 311 may include a first surface 3111 and a second surface 3112 that are sequentially arranged. The second surface 3112 may be configured to surround an outer side of the first surface 3111 in a circumferential direction, and form a preset inclination angle with the first surface 3111. The electron beams 140 emitted by the cathode 210 may be focused on the second surface 3112.

In some embodiments, the second surface 3112 may form the preset inclination angle with the first surface 3111 for line-focused projection of the electron beams 140, and the preset inclination angle may be to be in a range of 7°-10°. For example, the preset inclination angle may be 7°, 8°, 10°, etc. The electron beams 140 bombard an edge (i.e., the second surface 3112) of the target disk 311 to generate an X-ray for diagnostic medical imaging.

In some embodiments, the X-ray tube may further include a tube core 150 and a bearing 112. The bearing 112 may be installed on the tube core 150 and the bearing 112 may be connected to the target disk 311. The bearing 112 may be configured to rotate to drive the target disk 311 to rotate around a centerline of the first surface 3111.

In some embodiments, the cathode assembly 200 and the target disk 311 may be installed inside the tube core 150, and the bearing 112 may be configured to drive the target disk 311 to rotate around the centerline of the first surface 3111 to dissipate heat for the target disk 311. The tube core 150 may be made of metal, ceramic, or glass to ensure that an interior of the X-ray tube is in a vacuum environment.

In some embodiments, the tube core 150 has a pipe 151 within the tube core 150 that corresponds to the second surface 3112, with an inlet of the pipe 151 located between the anode assembly 300 and the cathode assembly 200. The focusing deflector structure 400 may be located on two sides of the inlet of the pipe 151, so that the electron beams 140 emitted by the cathode 210 may enter the pipe 151 through the inlet of the pipe 151 with the cooperation of the focusing electrode 220 and the focusing deflection structure 400, and strike on the second surface 3112. The pipe 151 may be provided to block a portion of the electron beams 140 away from a center of the focal point, thereby reducing an interference with the focal point on the target disk 311.

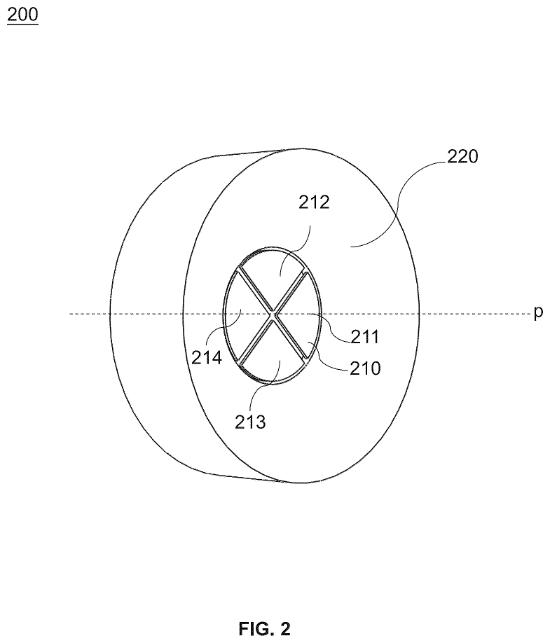

FIG. 2 is a schematic diagram of an exemplary cathode assembly according to some embodiments of the present disclosure. As shown in FIG. 2, the cathode assembly 200 may include the cathode 210 and the focusing electrode 220.

The cathode 210 may include at least two emission portions each of which may be configured to independently emit an electron beam, and the at least two emission portions may be arranged around a center of the cathode 210.

The cathode refers to a component of the cathode assembly of an X-ray tube that may be configured to generate an electron beam. The basic principle of an X-ray tube is to heat a cathode to emit electrons that are accelerated under a high voltage and strike an anode target, thereby producing an X-ray. The cathode is a key component of the X-ray tube, which generates the X-ray by providing a stable, concentrated, and efficient source of electrons.

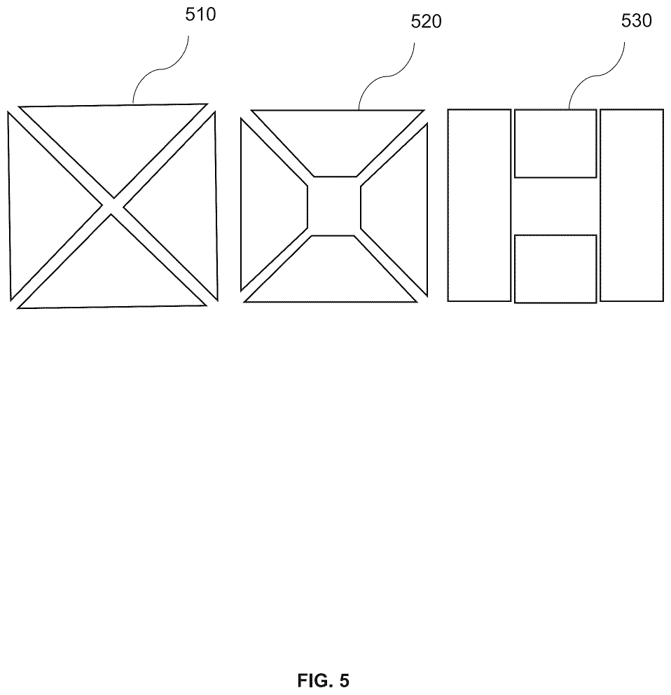

The emission portion refers to a component of the cathode 210 configured to emit electrons. In some embodiments, a count of the at least two emission portions may be 2, 3, 4, 5, etc. Preferably, the count of the at least two emission portions may be an even number and the even number of emission portions may be symmetrically disposed around the center of the cathode. By way of example, FIG. 2 shows the cathode 210 with four emission portions, wherein each 90°-angled sector denotes an emission portion, and one or more cathode sheets may be included within an emission portion. For example, the cathode 210 may include an emission portion 211, an emission portion 212, an emission portion 213, and an emission portion 214. More descriptions of a structure of the emission portion may be found in FIGS. 5-11 and the related descriptions thereof.

In some embodiments, each of the at least two emission portions may be configured to independently emit an electron beam. In other words, a current of each of the at least two emission portions may be controlled independently. Independent emission means that the at least two emission portions do not interfere with each other when emitting the electron beam, e.g., the at least two emission portions may emit the electron beams at the same time, or some of the at least two emission portions may emit electron beams, and the emission portions that do not emit electron beams do not affect a normal operation of the emission portions that emit electron beams. In some embodiments, the emission portion 211, the emission portion 212, the emission portion 213, and the emission portion 214 may emit the electron beams in any combination. For example, the emission portion 211 and the emission portion 214 may emit electron beams, while the emission portion 212 and the emission portion 213 do not emit electron beams. As another example, the emission portion 211 may emit an electron beam, while the emission portion 212, the emission portion 213, and the emission portion 214 do not emit electron beams.

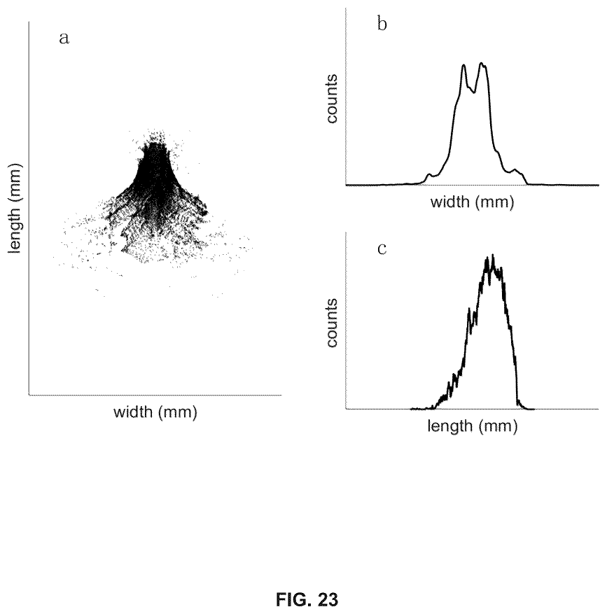

Understandably, selecting different emission portions to emit the electron beams may result in variations in a count and a position of emitted electron beams, which in turn causes differences in a size and a position of a beam spot (i.e., a focal point) formed on an anode (see FIGS. 23 to 26). An adjustment of the size of the beam spot formed by the electron beams on the anode may be achieved by changing the count or the position of the emission portions emitting electron beams, or reconfiguring the emission portions that emit electron beams.

Merely by way of example, if an ultra-small focal point is required, only one of the four emission portions may be configured to emit an electron beam. If a small focal point is required, any two of the four emission portions may be configured to independently emit an electron beam, respectively. If a large focal point is required, any three of the four emission portions may be configured to independently emit an electron beam, respectively. If an ultra-large focal point is required, all of the four emission portions may be configured to emit electron beams simultaneously. This emitting configuration minimizes a difference in current amplitudes of the emission portions, thereby increasing a service life of the cathode 210. In addition, by configuring a smaller count of emission portions to emit electron beams when a relatively small focal point is required, and configuring a larger count of emission portions to emit electron beams when a relatively large focal point is required, on one hand, a continuous change from an ultra-small focal point to an ultra-large focal point can be achieved, thereby improving an adaptability of the X-ray tube, on the other hand, the difference in required current amplitudes can be minimized, thereby improving a stability of the electron beams. Moreover, by configuring each of the at least two emission portions to independent emit electron beams, if a single or some of the at least two emission portions fail(s), other emission portion(s) or combination(s) of emission portion(s) can be used as replacements, ensuring continuity of performance.

In some embodiments, the at least two emission portions may be arranged around a center of the cathode. The center may be a geometric center of the cathode, for example, the center may be a location on the cathode crossed by the central axis p in FIG. 2.

Exemplarily, the emission portion 211, the emission portion 212, the emission portion 213, and the emission portion 214 may be arranged in a circumferential direction around the geometric center axis p of the cathode.

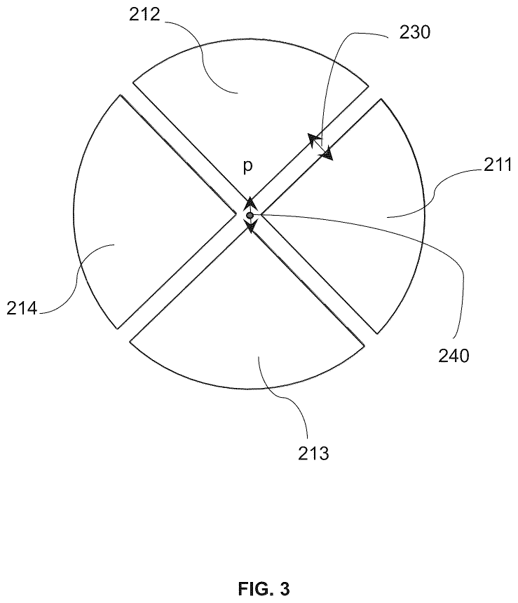

In some embodiments, adjacent edges of any two adjacent emission portions of the at least two emission portions may be parallel. FIG. 3 is a schematic diagram of an exemplary cathode according to some embodiments of the present disclosure. As shown in FIG. 3, adjacent edges of any two adjacent emission portions (e.g., the emission portion 211 and the emission portion 212, the emission portion 213 and the emission portion 214, the emission portion 214 and the emission portion 213, and the emission portion 213 and the emission portion 211) are parallel. Adjacent edges refer to closest edges of two adjacent emission portions. In this embodiment, for every two adjacent emission portions, the adjacent edges are parallel, and there is a gap between the two adjacent emission portions, which can contribute to heat dissipation of a cathode sheet.

In some embodiments, each of the at least two emission portions may include at least one cathode sheet. For example, an emission portion may include one cathode sheet or may include two or more cathode sheets. Understandably, one cathode sheet may be used as an emission portion, or two or more cathode sheets may be used as an emission portion, which is not limited by this embodiment.

In some embodiments, the cathode sheet may be made of a metal material or an alloy material. For example, the cathode sheet may be made of tungsten, niobium, a material doped with a certain percentage of tungsten, or the like. In some embodiments, the cathode sheet may include an emission surface. The emission surface is a surface in the cathode sheet where electrons are generated.

In some embodiments, the cathode may also be a thin film cathode. The thin film cathode may be laid directly on a base of the cathode assembly.

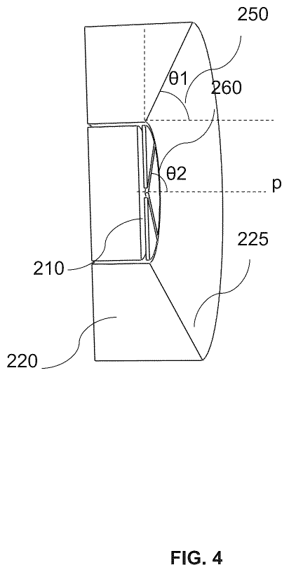

In some embodiments, an emission surface of the at least one cathode sheet may form a second acute angle with the central axis of the cathode. More descriptions of the second acute angle may be found in FIG. 4 and its related descriptions.

FIG. 4 is a cross-sectional view of an exemplary cathode assembly according to some embodiments of the present disclosure.

In some embodiments, an emission surface of at least one cathode sheet may form a second acute angle with a central axis of a cathode. In FIG. 4, a surface of the cathode sheet facing the central axis direction p of the cathode is the emission surface of the cathode sheet. When there are a plurality of cathode sheets, each of the plurality of cathode sheets may have an emission surface.

The second acute angle is an angle between the emission surface of the at least one cathode sheet and the center axis of the cathode.

In some embodiments, the second acute angle may be in a range of 45°≤θ2≤86°. For example, the second acute angle may be 45°, 50°, 60°, 70°, 80°, 86°, etc.

In some embodiments, the angle between the emission surface of the at least one cathode sheet and the center axis of the cathode may also be 90°, e.g., as illustrated by θ2 of FIG. 4, wherein a surface of the cathode sheet is perpendicular to the center axis p.

In some embodiments, angles between each of two or more cathode sheets and the central axis of the cathode are equal. For example, each of the four cathode sheets is at a second acute angle 260 to the center axis p of the cathode. It may be understood that the smaller the second acute angle 260 is, the greater a focusing strength may be.

In some embodiments, by setting θ2 to be in a range of greater than or equal to 45° and less than or equal to 86°, the cathode of the entire X-ray tube forms a quasi-spherical structure, which causes the entire cathode assembly to be a nearly spherical Pierce cathode gun, thereby allowing better beam spot uniformity of the electron beam and improving the serive life of the target disk of the X-ray tube.

In some embodiments, the angle θ2 between the cathode of the X-ray tube and the central axis p of the cathode is 45°. In some embodiments, the angle θ1 between the cathode of the X-ray tube and the central axis p of the cathode is 86°. In some embodiments, the angle θ2 between the cathode of the X-ray tube and the central axis p of the cathode is 50°. In some embodiments, the angle θ1 between the cathode of the X-ray tube and the central axis p of the cathode is 70°.

In some embodiments, the angle θ2 between the cathode of the cathode assembly of the X-ray tube and the central axis p of the cathode may also be in a range of 60°≤θ2≤80°. By setting θ2 within the range of 60° to 80°, the cathode of the entire X-ray tube forms a quasi-spherical structure, which makes the entire cathode assembly an approximately spherical Pierce cathode gun, thereby resulting in better uniformity of the beam spot of the electron beam 140, and extending the serive life of the target disk of the X-ray tube.

In some embodiments, the angle θ2 between the cathode of the X-ray tube and the central axis p of the cathode is 60°. In some embodiments, the angle θ2 between the cathode 100 of the X-ray tube and the central axis p of the cathode 100 is 80°. In some embodiments, the angle θ2 between the cathode 100 of the X-ray tube and the central axis p of the cathode 100 is 65°. In some embodiments, the angle θ2 between the cathode 100 of the X-ray tube and the central axis p of the cathode 100 is 75°.

In some embodiments, by setting each of two or more cathode sheets to form a same angle with the central axis, and setting the angle between the emission surface of the cathode sheet and the central axis of the cathode within the range of 45° to 86°, the cathode of the entire X-ray tube forms a quasi-spherical structure, so that the entire cathode assembly forms an approximately spherical Pierce cathode gun, thereby improving the uniformity of the beam spot of the electron beam and extending the service life of the target disk of the X-ray tube.

The Pierce electron gun may achieve better laminar beam focusing, thus improving the uniformity of the beam spot and extending the service life of the target disk of the X-ray tube. However, the Pierce electron gun generally requires the cathode to be spherical or cylindrical, which is challenging to achieve for high-performance thermionic cathodes. In this embodiment, by using multiple cathode sheets forming acute angles with a direction of the beam flow, a focusing effect similar to that of a spherical Pierce gun is achieved.

In some embodiments, shapes of the two or more cathode sheets (the cathode sheets of the at least two emission portions) may be the same, sizes of the two or more cathode sheets may be equal, and the two or more cathode sheets may be uniformly arranged along a circumferential direction of the cathode. The shapes and the sizes of the two or more cathode sheets being the same, respectively may include that the shape and the size of cathode sheets of a same emission portion may be the same, respectively, or the shape and the size of cathode sheets of different emission portions may be the same, respectively, or the shape and the size of cathode sheets of all emission portions may be the same, respectively. For example, each of the four emission portions in FIG. 3 may include one cathode sheet that is shaped as a 90° sector and the four cathode sheets of the four emission portions are equal in size. The four cathode sheets of the four emission portions may be uniformly arranged along the circumferential direction of the central axis p of the cathode.

In some embodiments, the two or more cathode sheets being uniformly arranged along the circumferential direction of the cathode means that the cathode sheets are equally spaced apart along the circumferential direction of the cathode, or that the cathode sheets are uniformly arranged circumferentially.

In some embodiments, to facilitate an adjustment of a size of the electron beam, the size of the the two or more cathode sheets may be set to be equal. For example, the cathode sheets in FIG. 3 are sectors (90° sectors, or quarter-circle shapes) of equal size.

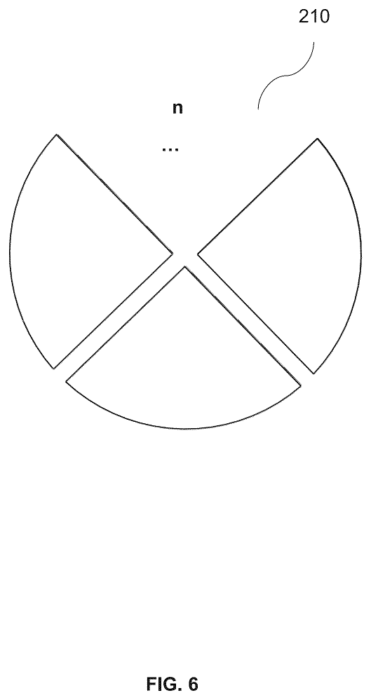

In some embodiments, the cathode sheets may have other shapes, e.g., see FIG. 5 and its related descriptions, and other counts, e.g., see FIG. 6 and its related descriptions.

FIG. 5 is a schematic diagram of exemplary cathodes with different shapes according to some embodiments of the present disclosure.

In some embodiments, the shape of the cathode sheets of the cathode may also be triangular, trapezoidal, or rectangular as shown in FIG. 5, or the like. It may be understood that the emission portions of the cathode may be uniformly arranged with equal intervals around a center of the cathode, e.g., as shown in the arrangement of the triangular cathode sheets 510 and the trapezoidal cathode sheets 520, or the emission portions of the cathode may be uniformly arranged with un-equal intervals around the center of the cathode, e.g., as shown in the arrangement of the rectangular cathode sheets 530.

FIG. 6 is an exemplary schematic diagram illustrating a count of cathode sheets of a cathode according to some embodiments of the present disclosure.

In some embodiments, the count of emission portions (cathode sheets) of the cathode may be adjusted as desired. For example, the count of emission portions of the cathode 210 of FIG. 6 may be set to n (n is a positive integer, such as 2, 3, 4, 5, etc.). The larger the count of emission portions n is, the greater a flexibility of the cathode assembly may be for an adjustment of a size of a focal point for different size requirements.

In some embodiments, a gap may be provided between the cathode sheets corresponding to the at least two emission portions. The gap refers to a gap between adjacent cathode sheets.

In some embodiments, the gap may include a gap between adjacent cathode sheets included within the same emission portion, or may include a gap between cathode sheets of different emission portions (i.e., a gap is provided between any of the emission portions). For example, see FIG. 3, any two adjacent cathode sheets have a first gap 230 between them, and any cathode sheets arranged opposite to each other has a second gap 240 between them. In the present disclosure, when two or more cathode sheets are used in combination, the first gap 230 and the second gap 240 may be configured based on a beam spot envelope distribution. Merely by way of example, the first gap 230 and the second gap 240 may be set to 0.5 mm, 0.1 mm, or the like. In some embodiments, a size of the first gap 230 and a size of the second gap 240 may be equal or unequal, which is not limited by the present disclosure.

The second gap 240 mainly affects the beam spot envelope distribution at the focal point when a plurality of cathode sheets are used in combination, and the specific size of the second gap may be set according to requirements.

The focusing electrode 220 may be arranged around a periphery of the cathode, and a first surface of the focusing electrode and an axial direction passing through the center of the cathode.

The focusing electrode is a component of an X-ray device configured to focus electrons emitted from a cathode.

In some embodiments, the focusing electrode 220 may be arranged around the periphery of the cathode 210. For example, the focusing electrode 220 in FIG. 2 is disposed around the cathode 210 and is centered on the geometric center axis p of the cathode.

In some embodiments, the surface of the focusing electrode 220 and an axial direction passing through the center of the cathode 210 may be at a first acute angle.

The first surface is a surface in the focusing electrode 220 on a same side as an emission surface of the cathode 210. For example, the first surface of the focusing electrode 220, which is also the side of the focusing electrode 220 toward the cathode 210 (e.g., a first surface 225), may be set at a first acute angle 250 with the axial direction passing through the center of the cathode 210, and the focusing electrode 220 may be configured to focus the electron beams emitted by the emission portions of the cathode 210. Setting the first acute angle allows the electron beams emitted by the emission portions of the cathode 210 to be Pierce-focused, ensuring uniformity of the electron beam spot.

The first acute angle is an angle between the first surface of the focusing electrode 220 and the axial direction passing through the center of the cathode 210. Exemplarily, the first acute angle 250 may be set as θ1 shown in in FIG. 5. It should be noted that by adjusting the first acute angle 250, a focusing strength of the focusing electrode 220 may be adjusted, i.e., the smaller the first acute angle 250 is, the stronger the focusing strength may be, and the larger the first acute angle 250 is, the weaker the focusing strength may be. In some embodiments, the first acute angle may be in a range of 45°≤θ1≤86°. For example, the first acute angle may be 45°, 50°, 60°, 70°, 80°, 75°, 65°, 86°, etc. In some embodiments, the first acute angle may be in a range of 60°≤θ1≤80°. For example, the first preset angle may be 60°, 65°, 70°, 80°, etc. Preferably, the first acute angle 250 may be equal to the second acute angle 260.

In some embodiments, a potential of the focusing electrode may be set to be the same as, or slightly lower than, a potential of the cathode to ensure that electrons do not bombard a surface of the cathode.

The cathode assembly provided in some embodiments of the present disclosure may include two or more cathode sheets (emission portions), and each of the two or more cathode sheets may be configured to independently emit an electron beam, so that a user may select different positions and counts of cathode sheets to emit electron beams according to actual needs, which enables more flexible adjustment of the size and position of the focal point of the electron beam. The size and the position of the focal point (i.e., the beam spot) formed by the electron beams emitted from different counts of cathode sheets and at different positions may be adjusted, thereby improving precision of electron beam treatment and an overall treatment effect. In addition, as the two or more cathode sheets in the cathode of the present disclosure are all set at an acute angle relative to the center axis p of the cathode, the entire cathode resembles a Pierce structure, which enhances the laminarity and uniformity of the electron beams, reduces a likelihood of the beams hitting an outer wall of a spherical tube during transmission, thereby minimizing damage to the tube wall and extending the service life of the tube and the entire X-ray tube.

On the other hand, the cathode assembly provided in some embodiments of the present disclosure allows each cathode sheet to emit an electron beam independently, which is conducive to the adjustment of the beam spot size and the focal point size, improves adaptability of the cathode assembly to different focal size requirements, and enables a continuous adjustment from an ultra-small focal point to an ultra-large focal point. Furthermore, under different focal point size requirements, a difference in the current passing through each emission portion is relatively small, which is beneficial for beam stability and the functional continuity of the cathode sheets, thereby extending the service life of the cathode sheets. The compact arrangement of the emission portions helps reduce an overall volume of the cathode assembly, making a structure of the cathode assembly more compact.

In practical applications, different focal spot size may correspond to different X-ray tube power, with a large focal point corresponding to a high power and a small focal point corresponding to a low power. If a single cathode needs to satisfy both high and low power requirements, the cathode temperature corresponding to the high power is relatively high, which affects the service life of the cathode sheet. In some embodiments of the present disclosure, by configuring a relatively small count of emission portions when a relatively small focal point size is needed, configuring a relatively large count of emission portions when a relatively large focal point size is needed, configuring a relatively large count of cathodes when a relatively large focal point size is needed, and configuring a single or a relatively small count of cathodes when a relatively small focal point is needed, the temperature of each cathode can be effectively ensured to be relatively low, thereby improving the service life of the cathode, meeting different tube power requirements, and effectively extending the service life of the cathode sheets.

Based on the same inventive concept, some embodiments of the present disclosure also disclose a cathode assembly with a fitting hole and an auxiliary electrode arranged within the fitting hole.

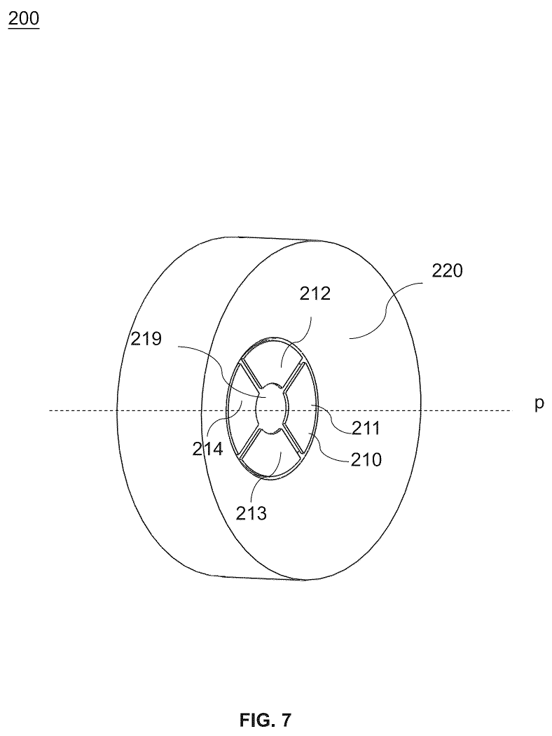

FIG. 7 is a schematic diagram of an exemplary cathode assembly comprising a fitting hole according to some embodiments of the present disclosure.

As shown in FIG. 7, the cathode assembly 200 includes the cathode 210 and the focusing electrode 220. The cathode 210 may include the emission portion 211, the emission portion 212, the emission portion 213, and the emission portion 214, which are arranged to form a circle, and a fitting hole 219 is formed in a center of the circle.

The fitting hole 219 may be configured to accommodate an auxiliary electrode. The auxiliary electrode may also be referred to as a grid electrode. For example, the above-described circle may be used as a fitting hole, and the emission portions may be arranged circumferentially around the auxiliary electrode.

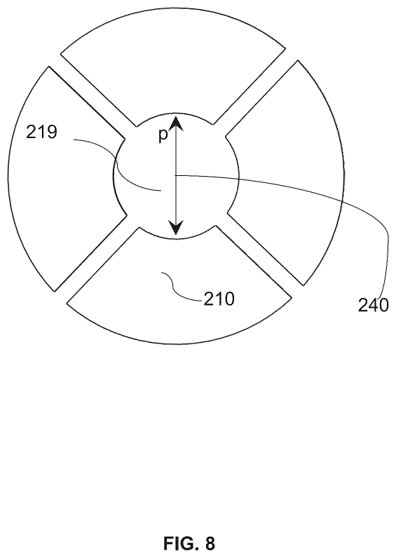

Referring to FIG. 8, FIG. 8 is a schematic diagram of an exemplary fitting hole according to some embodiments of the present disclosure.

In some embodiments, a diameter of the fitting hole 219 may be equal to a second gap 240 between any two opposite cathode sheets in the cathode assembly. A size of the second gap 240 may be equal to the diameter of the fitting hole 219.

In some embodiments, the cathode assembly may further include an auxiliary electrode. The auxiliary electrode may be arranged within the fitting hole surrounded by the at least two emission portions.

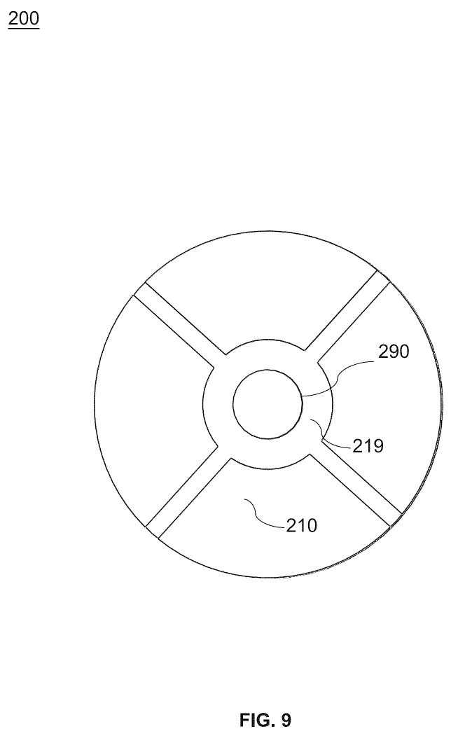

Referring to FIG. 9, FIG. 9 is a schematic diagram of an exemplary fitting hole and an exemplary auxiliary electrode according to some embodiments of the present disclosure.

As shown in FIG. 9, an auxiliary electrodes 290 may be provided within the fitting holes 219 surrounded by the emission portions of the cathode 210.

In some embodiments, a center of the auxiliary electrode 290 may be the same as a center of the cathode.

In some embodiments, there may be a gap between the auxiliary electrode 290 and the emission portions of the cathode, i.e., a diameter of the fitting hole may be larger than a diameter of the auxiliary electrode.

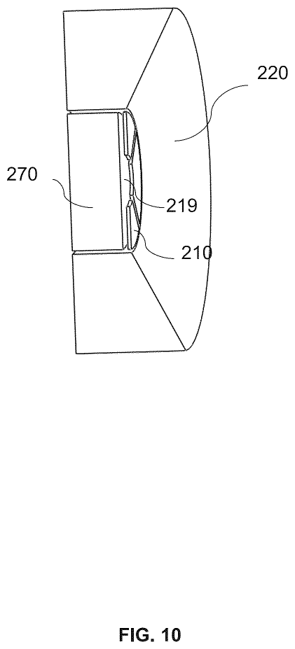

FIG. 10 is a cross-sectional view of an exemplary cathode assembly comprising a fitting hole according to some embodiments of the present disclosure.

As shown in FIG. 10, the emission portions of the cathode 210 forms a fitting hole 219 around a center of the cathode. The cathode 210 is provided above a base 270 (in an axial direction along the center of the cathode), and the focusing electrode 220 is provided around the base 270 and the cathode 210.

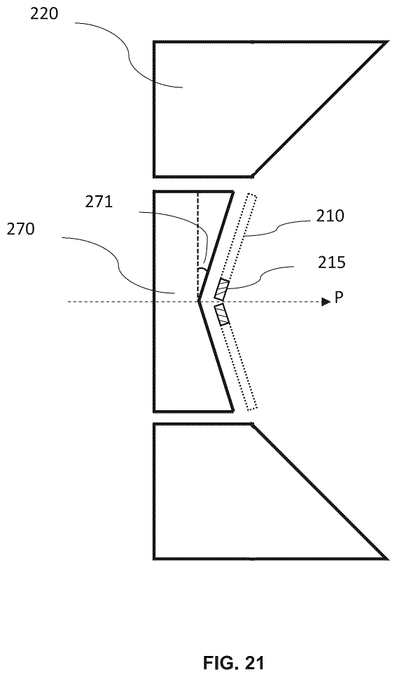

A detailed description of the base 270 may be found in the description of FIG. 21.

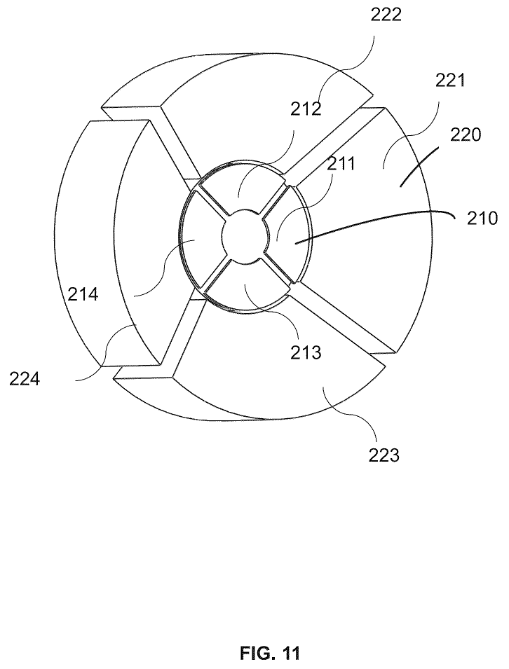

FIG. 11 is a schematic diagram of an exemplary focusing electrode of a cathode assembly according to some embodiments of the present disclosure.

In some embodiments, the focusing electrode 220 may include at least two focusing poles. The at least two focusing poles may be obtained by dividing the focusing electrode, and thus the focusing poles may also be referred to as focusing sub-electrodes of the focusing electrode. In some embodiments, first surfaces of the at least two focusing poles may form a circular structure, which may be arranged around the cathode.

In some embodiments, the at least two focusing poles may be arranged in a one-to-one correspondence with the at least two emission portions of the cathode. For example, one focusing pole may correspond to one emission portion. Exemplarily, the cathode 210 may include the emission portion 211, the emission portion 212, the emission portion 213, and the emission portion 214, as shown in FIG. 11. The focusing electrode 220 may include a focusing pole 221, a focusing pole 222, a focusing pole 223, and a focusing pole 224. The emission portions and the focusing poles may correspond to each other in a one-to-one manner in a radial direction of the cathode. For example, the emission portion 211 corresponds to the focusing pole 221; the emission portion 212 corresponds to the focusing pole 222; the emission portion 213 corresponds to the focusing pole 223; and the emission portion 214 corresponds to the focusing pole 224.

In some embodiments, the at least two focusing poles may be insulated from each other. The insulation may be achieved by the gap between the focusing poles or by providing an insulating layer between the focusing poles, which is not limited by this embodiment.

In the present embodiment, each of the at least two focusing poles may individually correspond to an emission portion. For example, a position and a shape of each of the at least two focusing poles may be matched with and controlled by the emission portion corresponding to the focusing pole. Therefore, by adjusting a voltage of a focusing pole on the focusing electrode, the focusing of the electron beam emitted by the corresponding emission portion can be controlled, which allows for adjustment of a count of target emission portions or redetermination of the target emission portions, thereby further enhancing a continuity and a range for the adjustment of the size of the beam spot and improving an adaptability of the cathode. At the same time, the focusing poles are adapted to their corresponding emission portions, making the structure of the cathode assembly more compact.

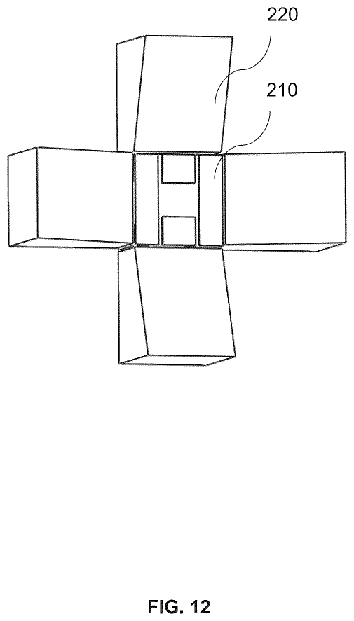

It should be noted that the shape of the focusing electrode is not limited to a circular shape. The shape of the focusing electrode may change accordingly with the shape of the cathode. For example, referring to FIG. 12, FIG. 12 is a schematic diagram of an exemplary rectangular focusing electrode according to some embodiments of the present disclosure.

Although the cathode sheets of the cathode 210 in FIG. 12 are rectangular, and the shapes of the focusing poles of the focusing electrode 220 are also rectangular, it should be noted that the shapes of the cathode sheets of the cathode being the same as or similar to the shapes of the focusing poles of the focusing electrode is only a preferred embodiment. In some embodiments, the cathode sheets of the cathode may be circular in shape and the focusing poles of the focusing electrode may still be rectangular in shape, which is not limited by this embodiment.

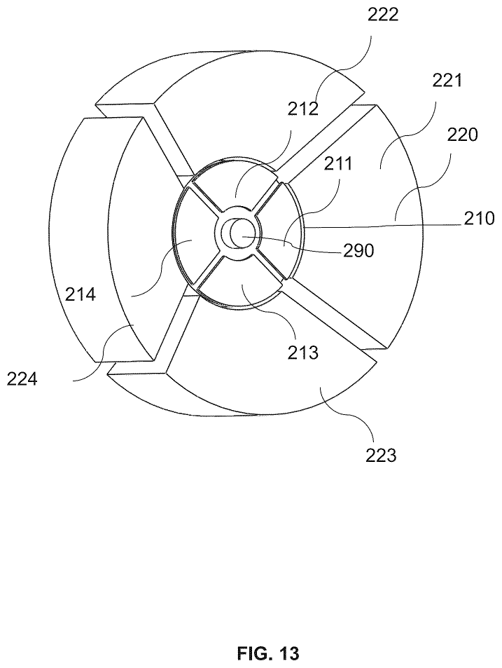

FIG. 13 is a schematic diagram of an exemplary cathode assembly according to some embodiments of the present disclosure.

In some embodiments, the auxiliary electrode 290 may be configured to cooperate with each of the at least two focusing poles to control the emission of an electron beam from the emission portion corresponding to the focusing pole.

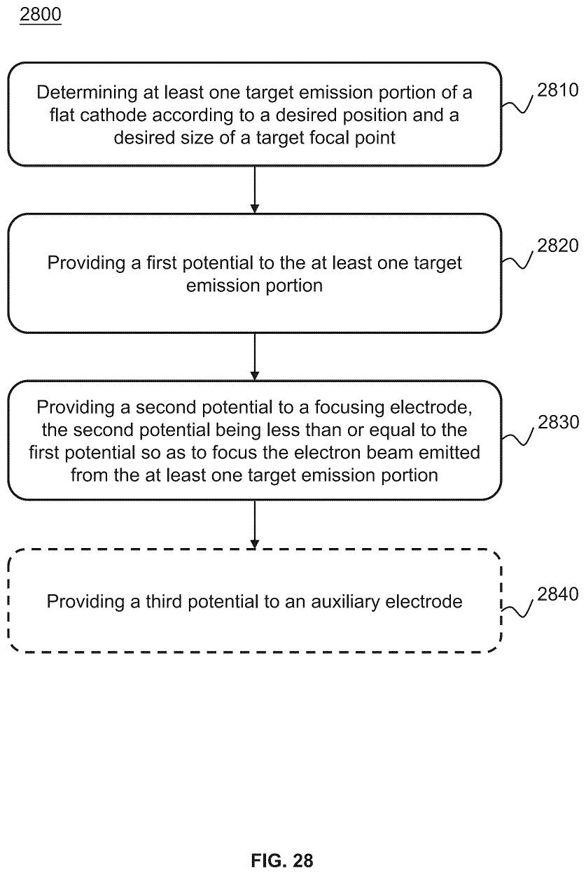

For example, after applying an electric potential (e.g., a third potential in FIGS. 28, 29, and 30) to the auxiliary electrode 290, the auxiliary electrode 290 may cooperate with each of the at least two focusing poles to control the emission of the electron beam from the emission portion corresponding to the focusing pole, thereby enabling further control of the focusing of the electron beams emitted by the emission portions, and improving the adaptability of the cathode assembly. By adjusting a potential difference between the auxiliary electrode 290 and the focusing poles, and by adjusting a potential of the auxiliary electrode, real-time switching of a tube current intensity, adjustment of the size and position of the beam spot, and focus deflection can be achieved, thereby further improving the adaptability of the cathode assembly.

In some embodiments, if the focusing electrode is an intergrated structure, the auxiliary electrode 290 may be provided in a fitting hole surrounded by the at least two emission portions, and the auxiliary electrode 290 may be configured to directly cooperate with the focusing electrode 220 to control the emission portions, thereby further controlling the focusing of the electron beams emitted by the emission portions and improving the adaptability of the cathode assembly.

In some embodiments, if the focusing electrode is a split structure, e.g., the focusing electrode is divided into the focusing pole 221, the focusing pole 222, the focusing pole 223, and the focusing pole 224, the auxiliary electrode 210 may cooperate with each of the focusing poles to achieve independent control of the emission portion corresponding to the focusing pole, respectively. For example, the auxiliary electrode 290 may cooperate with the focusing pole 221 to realize control of the emission portion 211, the auxiliary electrode 290 may cooperate with the focusing pole 222 to realize control of the emission portion 212, and the auxiliary electrode 290 may cooperate with the focusing pole 223 to realize control of the emission portion 213, and the auxiliary electrode 290 may cooperate with the focusing pole 224 to realize control of the emission portion 214.

The control of the emission portion may be understood as control of the electron beam emitted by the emission portion. In other words, the auxiliary electrode may be configured to adjust an intensity of the electron beam passing through the focusing electrode. By adjusting the intensity of the electron beam by the auxiliary electrode, the intensity of the electron beam may be adapted to meet different usage requirements.

In some embodiments, an insulating layer may be provided between the auxiliary electrode and the at least two emission portions. For example, the gap between the auxiliary electrode and the at least two the emission portions of the cathode in FIG. 13 may be at least partially filled with the insulating layer.

In some embodiments, a thickness of the insulating layer may be less than or equal to 1 mm. The thickness of the insulating layer may be less than or equal to the gap between the auxiliary electrode and the at least two emission portions of the cathode to ensure that the insulating layer is able to be set up and to ensure heat dissipation of the gap.

In some embodiments, the insulating layer may be made of a ceramic material or a ceramic composite material. For example, the insulating layer may be made of a graphene ceramic composite material, silicide ceramics, high-temperature glasses (e.g., quartz glass), or the like.

In some embodiments, the insulating layer may be provided on an insulating base (not shown in the drawing) and extend into the gap between the auxiliary electrode 290 and the at least two emission portions. For example, the insulating layer may be part of the insulating base, and the insulating layer and the auxiliary electrode may be combined by any mechanical bonding means (e.g., gluing, threaded connection, etc.).

In this embodiment, the insulating layer is provided between the auxiliary electrode and the at least two emission portions, which can prevent the auxiliary electrode from being pierced under high voltage, thereby improving the overall stability of the cathode assembly.

In some embodiments, the auxiliary electrode 290 may include at least two auxiliary poles (not shown in the drawing). The at least two auxiliary poles may be understood as auxiliary sub-poles obtained by dividing the auxiliary electrode.

The at least two auxiliary poles may be configured to cooperate with the focusing electrode to achieve control of the electron beams emitted by the at least two emission portions.

In some embodiments, the at least two auxiliary poles may be arranged in a one-to-one correspondence with the at least two focusing poles and/or the at least two emission portions. For example, the at least two auxiliary poles may be arranged in a one-to-one correspondence with the at least two focusing poles, and the at least two auxiliary poles may also be arranged in a one-to-one correspondence with the at least two emission portions. For example, a count of the auxiliary poles, a count of the focusing poles, and a count of the emission portions may be the same, with one auxiliary electrode, one focusing electrode, and one emission portion being sequentially arranged outward from the geometric center point p of the cathode along a radius of the cathode. In terms of shape arrangement, the one auxiliary pole, the one focusing pole, and the one emission portion may form a sector structure.

In some embodiments, when the auxiliary electrode includes a plurality of auxiliary poles, the focusing electrode may be an integrated structure. For example, the focusing electrode may not include separate focusing poles.

In this embodiment, the at least two auxiliary poles, the at least two focusing poles, and the at least two emission portion are configured as a one-to-one correspondence structure. This configuration has at least three beneficial effects. Firstly, this configuration facilitates replacement of a damaged component when part of the structure is damaged. Secondly, when only part of the emission portions is required to emit electron beam(s), it is possible to use only the auxiliary pole(s) and the focusing electrode(s) corresponding to the required emission portion(s), thereby improving the service life of the components, reducing energy consumption, and enhancing the precision and flexibility of control of the electron beams emitted by the emission portions. Thirdly, the shape of the auxiliary poles is adapted to the shape of the emission portions, which helps make the structure of the cathode assembly more compact.

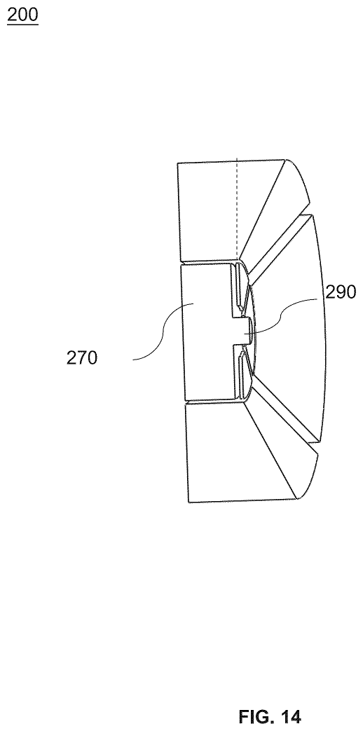

FIG. 14 is a cross-sectional view of an exemplary cathode assembly comprising an auxiliary electrode according to some embodiments of the present disclosure.

In some embodiments, the auxiliary electrode 290 may be fixed to the base 270.

In some embodiments, the auxiliary electrode 290 may be integrally molded with the base 270 or may be fixedly connected with the base 270 in various ways, e.g., welded, riveted, or the like.

Some of the embodiments described above in the present disclosure disclose a technical solution for a cathode with a split structure in which each cathode sheet (or emission portion) may be independently controlled. A single cathode sheet corresponds to an ultra-small focal point (or a low tube current), a relatively small count of cathode sheets correspond to a relatively small focal point (or a medium tube current), and a relatively large count of cathode sheets correspond to a relatively large focal point (or a high tube current). This configuration minimizes a difference in the current amplitude emitted by the cathode sheets, thereby improving the service life of the cathode sheets. Simultaneously, configuring a relatively small count of cathode sheets corresponding to a relatively small focal point, and a relatively large count of cathode sheets corresponding to a relatively large focal point minimizes the required field amplitude difference for beam control, which helps stabilize the beam. Moreover, independent control of the two or more cathode sheets ensures that a same functionality can be achieved by combining other cathode sheets in the event of a failure of one cathode sheet, thereby maintaining performance continuity.

Additionally, when combined with a Pierce focusing pole, a better laminar beam can be induced to obtain a more uniform beam spot distribution. Furthermore, through the cooperation between each of the two or more cathode sheets and the focusing electrode corresponding to the cathode sheet, independent control of the beam flow of each of the two or more cathode sheets, such as on/off control of the cathode sheet, focus deflection, and modulation of the position of the cathode sheet, the beam spot envelope, etc., can be achieved. Meanwhile, the position of each cathode sheet is different, and by configuring parameters such as the gap between the cathode sheets, natural focus deflection can be achieved by controlling the current emission of different cathode sheets, and multiple focal points can be simultaneously achieved on the target disk, thereby improving imaging quality.

Moreover, in addition to using the Pierce focusing pole, setting the cathode sheets of the cathode 210 at the second acute angle with respect to the beam direction of the electron beams emitted by the emission portions can make the cathode 210 resemble a Pierce structure.

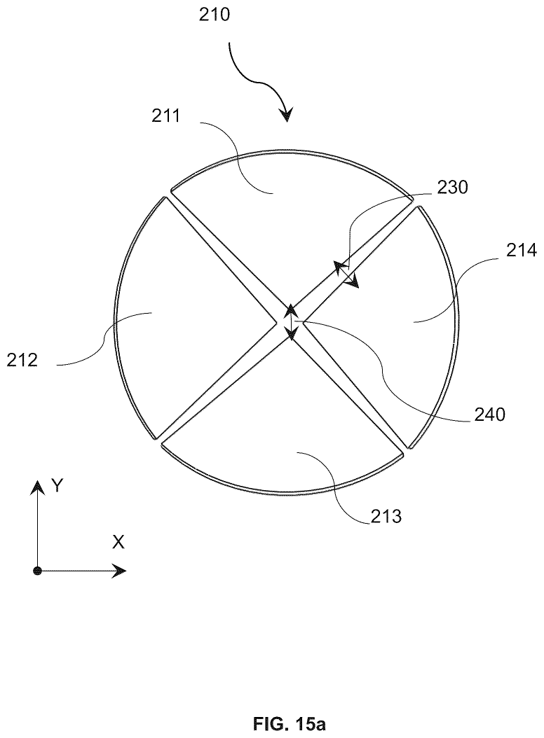

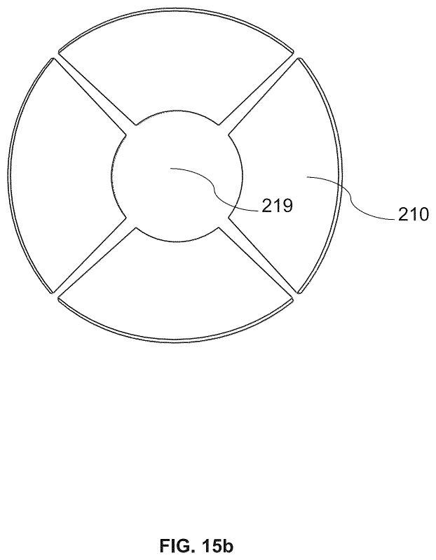

FIG. 15a is a schematic diagram of an exemplary spherical-like cathode according to some embodiments of the present disclosure.

To achieve optimal laminar flow regulation, electrical focusing is required to ensure that the electron beams are emitted as nearly parallel beams. To achieve strong electrical focusing while ensuring better laminar flow of the electron beams, the cathode may be adjusted from a flat surface to a cylindrical or spherical surface. A cathode cannot be directly made into a cylindrical or spherical shape, therefore, a plurality of cathode sheets may be spatially arranged at an angle to achieve an approximate cylindrical or spherical structure.

As shown in FIG. 15a, the four emission portions of the cathode 210 of the cathode assembly 200 may be set up in accordance with a certain wedge angle as a spherical-like structure. Specifically, the first gap 230 between adjacent emission portions tapers from a center of the cathode assembly in a radial direction along a beam direction of electron beams emitted by the cathode 210, and the second gap 240 of any of the emission portions at the center of the cathode assembly may be the same.

Exemplarily, the emission portion 211, the emission portion 212, the emission portion 213, and the emission portion 214 may be sector-shaped, and the four emission portions may be arranged according to a specific wedge angle such that the emission surface of each emission portion forms a second acute angle with the beam direction of the electron beams. By configuring the cathode sheets in a sector shape, the cathode 210 formed by the cathode sheets arranged circumferentially around the center of the cathode 210 is a circular structure. Furthermore, by configuring the angle between the emission portions and the beam direction (i.e., the axis p) of the electron beams to be a second acute angle, the cathode 210 can form a spherical-like structure, and the cathode assembly is a nearly spherical Pierce cathode gun.

In some embodiments, if the cathode is required to emit a relatively good laminar beam, the second acute angle may be adjusted so that the electron beams are emitted by the cathode in a nearly parallel, slightly divergent, or slightly focused manner.

Referring to FIG. 15b. FIG. 15b is a schematic diagram of another exemplary spherical-like cathode according to some other embodiments of the present disclosure. FIG. 15b, as compared to FIG. 15a, adds the fitting hole 219 in the center of the cathode 210. Similarly, the emission portions of the cathode are arranged at a certain wedge angle, so that the entire cathode forms a spherical-like structure. The fitting hole 219 may be configured to accommodate an auxiliary electrode inside the fitting hole 219.

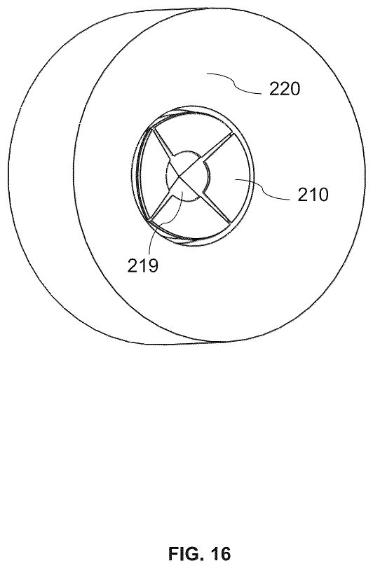

FIG. 16 is a schematic diagram of an exemplary cathode assembly comprising a cathode with a spherical-like according to some embodiments of the present disclosure.

In FIG. 16, the cathode 210 is configured as a spherical-like structure, a plurality of emission portions form the fitting hole 219 around a beam direction of electron beams emitted from the falt cathode 210, and the focusing electrode 220 is provided around the cathode 210.

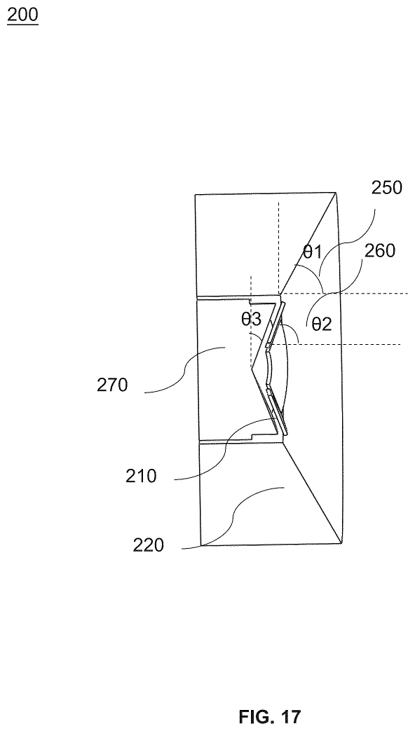

FIG. 17 is a cross-section of the cathode assembly shown in FIG. 16 of the present disclosure.

FIG. 17 illustrates second acute angle 260 between the emission portions of the cathode 210 and a beam direction of electron beams, and first acute angle 250 between the focusing electrode 220 and the beam direction (a line parallel to the beam direction in the drawing) of the electron beams.

In some embodiments, the base 270 may be configured as a wedge-shaped structure as shown in FIG. 17. For example, a surface of the base facing the emission portions may be configured to form a wedge angle θ3 with respect to a radial direction perpendicular to the beam direction of the electron beams, and a value of the wedge angle θ3 may be set according to requirements, e.g., 30°, 45°, or the like.

In some embodiments, the first acute angle 250 and the second acute angle 260 may be equal. For example, both the first acute angle 250 and the second acute angle 260 may be configured to be in a range of 45° to 86°.

In some embodiments, the wedge angle θ3 may be complementary to the second acute angle 260 or the first acute angle 250, i.e., a sum of the wedge angle θ3 and the second acute angle, or a sum of the wedge angle θ3 and the first acute angle is 90°.

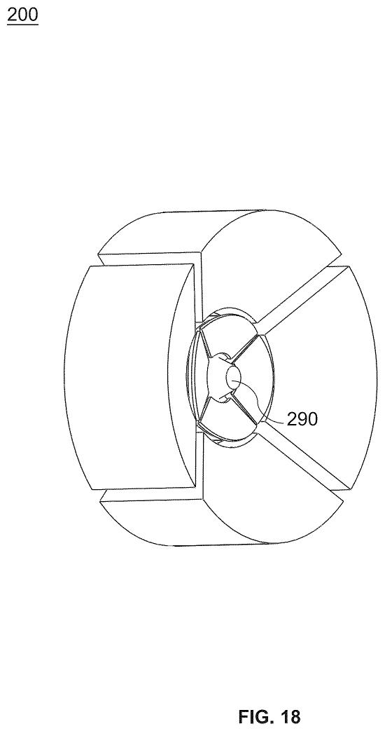

FIG. 18 is a schematic diagram of an exemplary cathode assembly including an auxiliary electrode according to some other embodiments of the present disclosure.

In some embodiments, the auxiliary electrode may be configured not to obstruct a movement of electron beams in a beam direction. Configuring the auxiliary electrode not to obstruct the movement of the electron beams in the beam direction ensures that the electron beams do not bombard a surface of the auxiliary electrode.

In some embodiments, since the beam direction may not be parallel to a central axis of the cathode when the electron beams emitted by the emitting portions are controlled by the focusing electrode and the auxiliary electrode, to prevent the electron beams from striking the surface of the auxiliary electrode, a structure of the auxiliary electrode may be designed with a gradually decreasing dimension along the beam direction. For example, a radial dimension of the auxiliary electrode may be configured to taper along the beam direction.

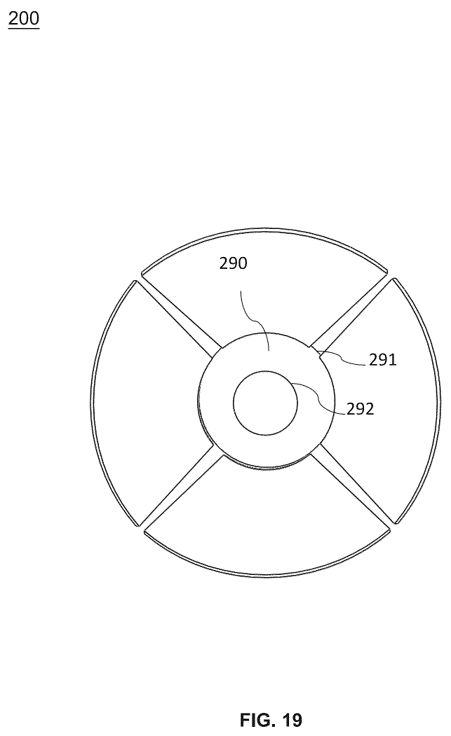

FIG. 19 is a schematic diagram of an exemplary cathode including an exemplary auxiliary electrode according to some embodiments of the present disclosure.

As shown in FIG. 19, the dimension of the auxiliary electrode 290 may vary along the beam direction (perpendicular to the surface of the paper in FIG. 19) from large to small. Specifically, a radial dimension 291 represents a maximum dimension of the auxiliary electrode, and a radial dimension 292 represents a minimum dimension of the auxiliary electrode.

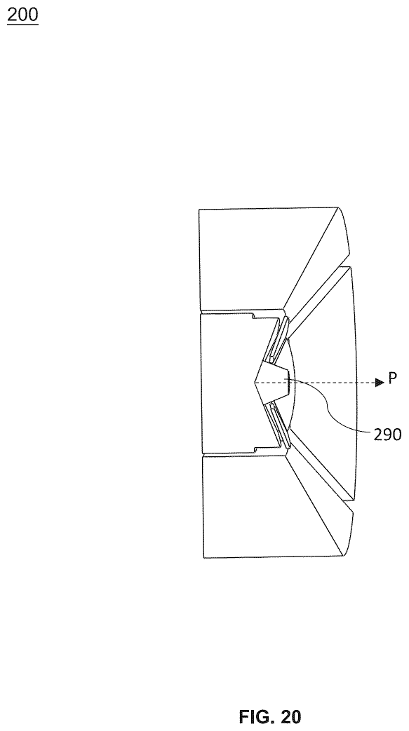

FIG. 20 is an exemplary cross-sectional view of a cathode assembly and an auxiliary electrode according to some embodiments of the present disclosure.

In the cathode assembly 200 as shown in FIG. 20, the radial dimension of the auxiliary electrode 290 gradually decreases in the beam direction (the p-direction), i.e., the radial dimension of the auxiliary electrode 290 gradually decreases along the direction of the arrow. For example, a radial dimension of an end of the auxiliary electrode 290 away from the base may be smaller than a radial dimension of an end of the auxiliary electrode close to the base. The decrease in the radial dimension of the auxiliary electrode may be linear or non-linear.

In this embodiment, by changing the radial dimension of the auxiliary electrode, a possibility of the electron beams emitted by the emission portions hitting the auxiliary electrode can be reduced, thereby improving the reliability of the cathode assembly.

FIG. 21 is an exemplary cross-sectional view of a cathode assembly according to some embodiments of the present disclosure.

In some embodiments, the cathode assembly 200 may further include the base 270, and the cathode 210 may be installed on the base 270.

In some embodiments, the cathode assembly 200 may also include an insulating base (not shown in the drawing) that may be connected to the base 270. The base 270 may be insulated from each of the at least two emission portions, each of the emission portions may be fixed to the insulating base by an insulating material passing through the base 270, and the focusing electrode 220 may be fixed to the insulating base by an insulating material. A side of the base 270 near the emission portions may have a corresponding surface parallel to an outer surface of each of the emission portions, thereby improving the stability of fixing the emission portions to the base 270. In some embodiments, a surface of the base 270 close to the emission portions may be parallel to an inner surface of the emission portions close to the base.

In some embodiments, the base 270 includes one or more installation surfaces each of which is configured to allow one or more cathode sheets to be installed on the base and each of the one or more installation surfaces of the base is parallel to a surface of the cathode sheet installed on the installation surface or forms a third acute angle 271 with the surface of the cathode sheet installed on the installation surface.

The installation surface is also the surface of the base 270 close to the emission portions. By making the installation surface on the base 270 configured to allow the corresponding cathode sheet to be installed on the base to be parallel to the surface of the corresponding cathode sheet, for example, if the surface of the cathode sheet is curved, the installation surface of the base 270 for mounting the corresponding cathode sheet is also curved. If the surface of the cathode sheet is planar, the installation surface of the base 270 for mounting the corresponding cathode sheet is also planar. In addition, a shape of the installation surface of the base 270 corresponds to a shape of the cathode 210, so as to make the mounting and fixing of each cathode sheet with the base 270 more convenient, and at the same time effectively ensure that the mounting angle of the cathode sheets relative to the central axis p of the cathode 210 is effectively maintained, resulting in minimal installation error between the two or more cathode sheets and thus higher precision of the electron beams emitted by the cathode.

The third acute angle 271 is an angle between the installation surface of the base and a surface or a line perpendicular to the center axis p of the cathode. The third acute angle may range from 4° to 45°. For example, the third acute angle may be 4°, 10°, 15°, 30°, 45°, etc.

In some embodiments, a gap may be provided between the cathode and the base. The gap between the cathode and the base is referred to as a third gap. By providing the gap between the cathode 210 and the base 270, the cathode 210 is made easy to dissipate heat.

In some embodiments, each of the at least one cathode sheet may be provided with an installation region.

The installation region is a region provided on the cathode and configured to allow the cathode to be installed and fixed. For example, the cathode may be fixed to the base 270 through the installation region. Providing the installation region enables cathode sheets adjacent to each other to be separated and spaced apart, which in turn makes the cathode sheets less likely to interact with each other when the cathode sheets conduct a current and emit an electron beam independently.

In some embodiments, a region in the cathode sheet other than the installation region is referred to as an emission region of electron beams, and the installation region and the emission region do not affect each other.

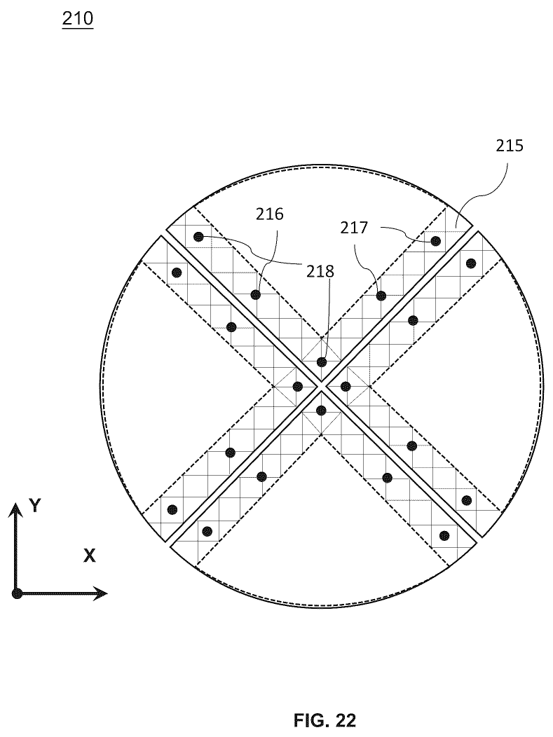

FIG. 22 is a schematic diagram of an exemplary installation region of a cathode according to some embodiments of the present disclosure.

As shown in FIG. 22, an installation region 215 may be provided with at least one current input position 216 and at least one current output position 217, a count of the at least one current input position 216 and a count of the at least one current output position 217 may be respectively equal to a count of the at least one cathode sheet, and the at least one current input position 216 and the at least one current output position 217 may be configured to control electron beam emissions of the at least one cathode sheet.

In some embodiments, the installation region 215 may also be provided with a fixing position 218, by which the cathode 210 may be fixed to the base.

The current input position 216 is a point on the cathode where current is input into the cathode sheet.

The current output position 217 is a point on the cathode where current is output from the cathode sheet.

When it is necessary for the cathode sheet to emit an electron beam, the current input position 216 and the current output position 217 may be connected to an external power source, so that the external power source supplies current to the cathode sheet, thereby causing the cathode sheet to emit the electron beam.

It should be noted that the installation region may also have other shapes, such as circular, cross-shaped, etc., and the position of the installation region may also be at other locations of the sector-shaped cathode sheet, for example, at an edge of an annular region. The current output position, the current output position, and the fixing position may also be at other locations, which are not limited by this embodiment.

In this embodiment, by providing the at least one current input position 216, the at least one current output position 217, and the fixing position 218 in the installation region, the circuit conduction of each cathode sheet is realized while ensuring that the two or more cathode sheets can be fixed securely. Each of the two or more cathode sheets has an independent circuit and does not interfere with each other.

Some of the above embodiments describe cathode assemblies in X-ray tubes, and in some embodiments, the X-ray tube 100 may also include a magnetic focusing assembly.

In some embodiments, the magnetic focusing assembly may include at least one magnetic focusing device. The magnetic focusing device may include a solenoid, a quadrupole magnet, or a guiding magnet. After the cathode assembly of the X-ray tube provided in some embodiments of the present disclosure emits electron beams, the magnetic focusing assembly may be configured to focus the electron beams, which, in turn, results in a better laminar uniformity of the electron beams that ultimately strike an anode target disk.

In some embodiments, the magnetic focusing assembly may be a quadrupole magnet. In some embodiments, the magnetic focusing assembly may be a solenoid. In some embodiments, the magnetic focusing assembly may be a guiding magnet. In some embodiments, the magnetic focusing assembly may be a solenoid and a quadrupole magnet. It should be noted that a count of the magnetic focusing devices that the magnetic focusing assembly may include, and whether the magnetic focusing device is a solenoid, a quadrupole magnet, or a guiding magnet is not specifically limited by the present disclosure, and it may be set according to the actual usage requirements.

In some embodiments, the X-ray tube 100 may further include a vacuum-enclosed casing, which may be constructed with a beam passageway. The beam passageway may be disposed between the cathode assembly and an anode target disk, and the magnetic focusing device may be provided on an outer side of the beam passageway. The beam passageway may have a length matching one magnetic focusing device. By setting the length of the beam passageway to match one magnetic focusing device, the beam passageway of the X-ray tube is made shorter, and the entire X-ray tube is more compact.

FIG. 23 is a schematic diagram of an exemplary beam spot distribution of a cathode assembly in a first operating mode according to some embodiments of the present disclosure.

The first operating mode refers to an operating mode of the cathode assembly in which only one emission portion of a cathode (e.g., the cathode 210) is in an operating state. When only one emission portion is operating (e.g., any one of the emission portion 211, the emission portion 212, the emission portion 213, or the emission portion 214), a minimum focal point may be achieved through the modulation of a Pierce gun and a quadrupole magnet. FIG. 23 shows the beam spot distribution at the focal point and the beam spot distribution in a width direction (an X-direction) and a length direction (a Z-direction) of the focal point when only one emission portion is operating. At this time, the width direction and the length direction of the focal point may satisfy an ultra-small focal point of IEC0.5*IEC0.5. A similar effect may be achieved when using any one of the remaining emission portions.

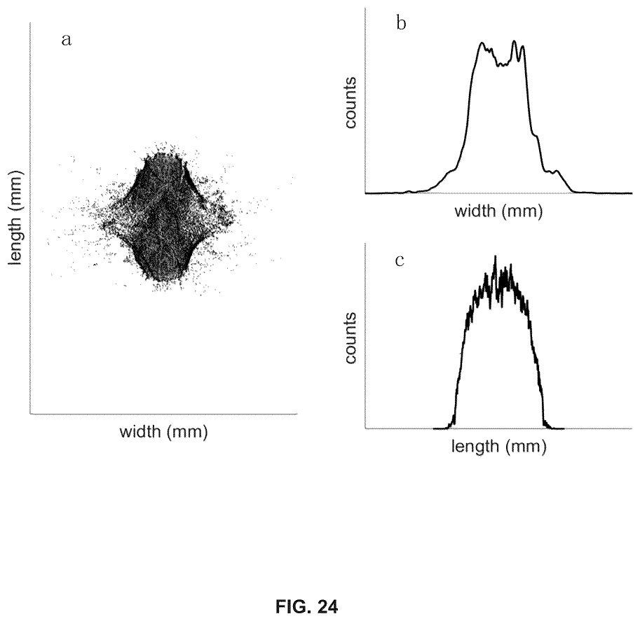

FIG. 24 is a schematic diagram of an exemplary beam spot distribution of a cathode assembly in a second operating mode according to some embodiments of the present disclosure.

The second operating mode refers to an operating mode of the cathode assembly in which two emission portions of a cathode (e.g., the cathode 210) are in an operating state. When two the emission portions are operating (e.g., any two of the emission portion 211, the emission portion 212, the emission portion 213, and the emission portion 214), a small focal point may be achieved through the modulation of a Pierce gun and a quadrupole magnet. FIG. 24 shows the beam spot distribution at the focal point and the beam spot distribution in the width direction (the X direction) and the length direction (the Z direction) of the focal point when two emission portions are used. At this time, the width direction and the length direction of the focal point may satisfy a small focal point of IEC0.9*IEC0.6. A similar effect may be achieved when using two other emission portions.

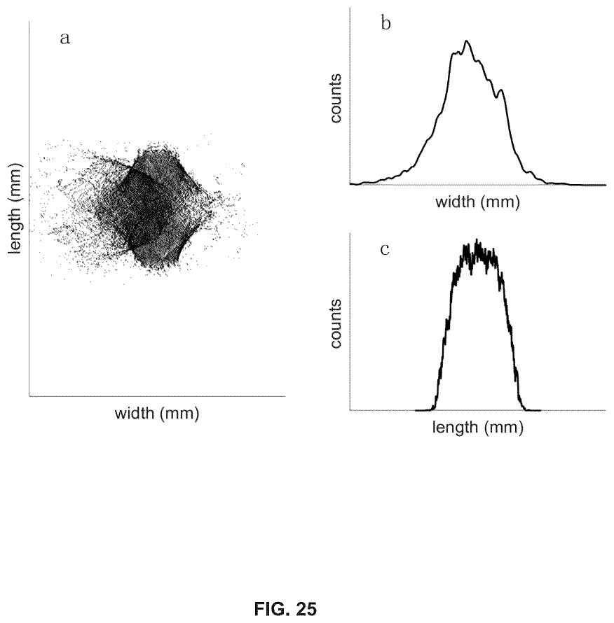

FIG. 25 is a schematic diagram of an exemplary beam spot distribution of a cathode assembly in a third operating mode according to some embodiments of the present disclosure.

The third operating mode refers to an operating mode of the cathode assembly in which three emission portions of a cathode (e.g., the cathode 210) are in an operating state. When three of the emission portions are used (e.g., any three of the emission portion 211, the emission portion 212, the emission portion 213, and the emission portion 214), a large focal point may be achieved through the modulation of a Pierce gun and a quadrupole magnet. FIG. 25 shows the beam spot distribution at the focal point and the beam spot distribution in the width direction (the X direction) and the length direction (the Z direction) of the focal point when three emission portions are used. At this time, the width direction and the length direction of the focal point may satisfy a large focal point of IEC1.2*IEC0.6. A similar effect may be achieved when using a combination of three other emission portions.

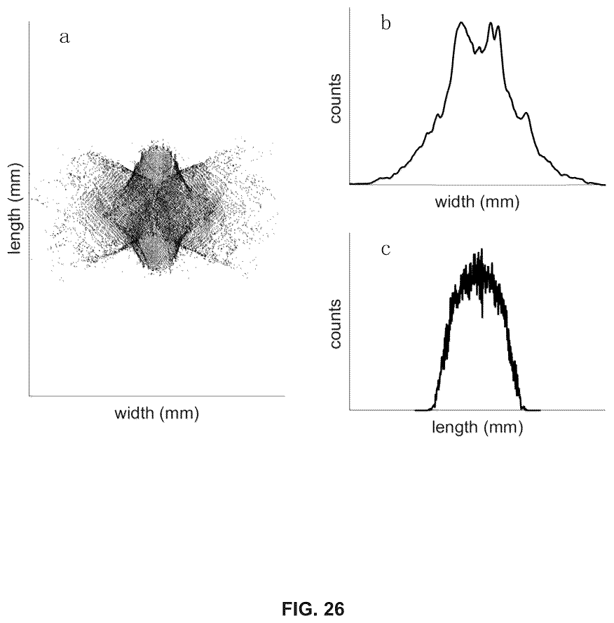

FIG. 26 is a schematic diagram of an exemplary beam spot distribution of a cathode assembly in a fourth operating mode according to some embodiments of the present disclosure.

The fourth operating mode refers to an operating mode of the cathode assembly in which four emission portions of a cathode (e.g., the cathode 210) are in an operating state. When four emission portions are used (e.g., emission portion 211, emission portion 212, emission portion 213, and emission portion 214), an ultra-large focal point may be achieved through the modulation of a Pierce gun and a quadrupole magnet. FIG. 25 shows the beam spot distribution at the focal point and the beam spot distribution in the width direction (the X direction) and the length direction (the Z direction) of the focal point when four emission portions are used. At this time, the width direction and the length direction of the focal point may satisfy an ultra-large focal point of IEC1.6*IEC0.6.

In this embodiment, a user may choose different counts of emission portions and emission portions at different positions to emit electron beams according to actual needs, thus making the adjustment of the size and position of the focal point of the beams more flexible. The size and position of the focal point formed by the electron beams emitted from the emission portions at different positions and in different counts are different, thus resulting in a higher therapeutic precision of the electron beams and a better therapeutic effect.

This approach allows for a continuous change from an ultra-small focal point to an ultra-large focal point to a certain extent, with minimal changes in beam control intensity and filament temperature, thereby effectively ensuring the stability, reliability, and service life of the cathode assembly. In practical clinical scenarios, four commonly used focal spot size can be selected for radiographic diagnosis, and in special cases, more options can be provided for clinical applications.

In some embodiments, when it is necessary to adjust the size of the beam spot or the size of the focal point, adjustments may be made by changing the potential of the focusing electrode 220 and altering the count of emission portions that emit the electron beams, or by reselecting the emission portions that need to emit the electron beams. This adjustment allows for the modification of the size of the electron beams emitted by the cathode 210, thereby adjusting the size of the beam spot on the anode target disk and further adjusting the size of the focal point. This enables a continuous variation of the focal point size from ultra-small to ultra-large, thereby improving the adaptability of the cathode assembly.

It should also be noted that the above descriptions of the operating modes are for the purpose of example only, and in practice, the specific count of the emission portions actually emitting the electron beams in each operating mode is not limited, which may be set according to requirements.

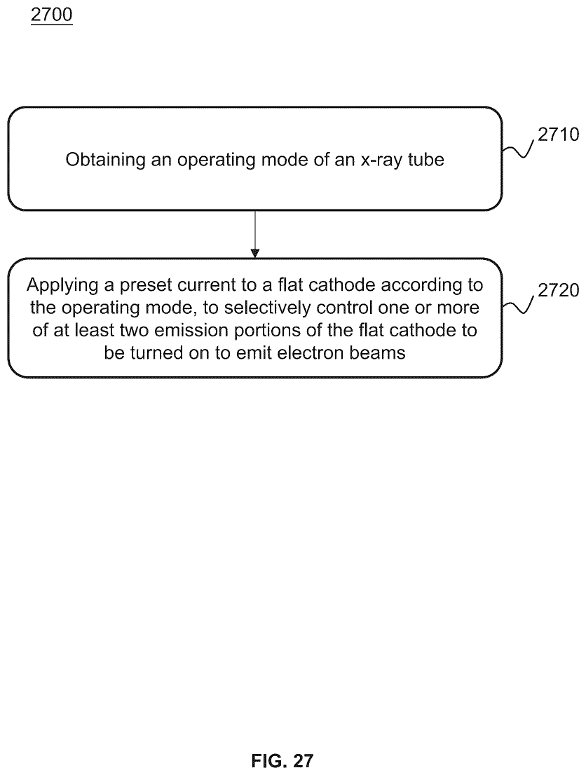

FIG. 27 is a flowchart of an exemplary process for adjusting a focal point of an X-ray according to some embodiments of the present disclosure. In some embodiments, process 2700 may be performed by a processing device or an X-ray focus adjustment system. In some embodiments, process 2700 may be executed using the cathode assembly described in the embodiment above. In some embodiments, process 2700 may include the following operations.

In 2710, an operating mode of the X-ray tube may be obtained.

The operating mode is a way of controlling the emission of an electron beam from the cathode assembly of an X-ray tube. For example, the operating mode may include a small focal point mode in which a single emission portion of at least two emission portions emits the electron beam and a large focal point mode in which two or more emission portions of the at least two emission portions emit the electron beams.

The small focal point mode is a mode that generates a relatively small focal point. The small focal point mode may be a mode in which a single emission portion of the at least two emission portions emits the electron beam. For example, in the small focal point mode, an ultra-small focal point as shown in FIG. 23 may be generated.

The large focal point mode is a mode that generates a relatively large focal point. The large focal point mode may be a mode in which two or more emission portions of the at least two emission portions emit the electron beams. For example, in the large focal point mode, focal points shown in FIG. 24, FIG. 25, or FIG. 26 may be generated.

It should be noted that the above operating modes are only examples, and the present disclosure does not limit the naming of the operating modes. For example, the small focal point mode may also be an operating mode that uses only two emission portions; and the large focal point mode may also be an operating mode that uses all emission portions. Also, the small focal point mode and the large focal point mode are relative concepts intended to illustrate a relationship between the size of different focal points, and are not intended to place a limitation on the count of emission portions emitting the electron beams in the operating mode.

In some embodiments, the operating mode may be obtained through user input or determined automatically by the processing device or the X-ray focal point adjustment system based on the size of the focal point. For example, the X-ray focus adjustment system may autonomously determine how many emission portions need to emit electron beams based on the size of the focal point. This embodiment does not limit the specific determination manner, which may employ various approaches.

In 2720, a preset current may be applied to the cathode according to the operating mode to selectively control one or more of the at least two emission portions of the cathode to be turned on and to emit the electron beams.

The preset current is an amount of current that is set in advance for each operating mode. For example, the amount of current that is applied to each emission portion may be preset for operating mode, and the corresponding preset current may be automatically acquired when switching to a different operating mode.

When the X-ray tube is in operation, the preset current may be applied to the cathode according to an acquired operating mode of the X-ray tube, thereby controlling one or more of the at least two emission portions of the cathode to be turned on, and enabling the X-ray tube to realize different operating modes.

FIG. 28 is a flowchart of an exemplary process for controlling a focused electron beam according to some embodiments of the present disclosure. In some embodiments, process 2800 may be performed by a processing device or an X-ray focus adjustment system. In some embodiments, process 2800 may be performed using the cathode assembly described in the embodiments above. In some embodiments, process 2800 may include one or more of the following operations.

In 2810, at least one target emission portion of a cathode may be determined according to a desired position and a desired size of a target focal point.

The target focal point is a desired focal point with a preset size and position. For example, the target focal point may include information such as the position and size of the focal point that a user wishes to obtain.

The target emission portion is an emission portion that needs to be turned on to emit the electron beam. For example, when the target focal point is an ultra-small focal point, the target emission portion may be one of at least two emission portions.

In some embodiments, a mapping relationship between the target emission portion and the target focal point may be preset, by which the processing device may determine a corresponding target emission portion based on the size of the target focal point.

In 2820, a first potential may be provided to the at least one target emission portion.

The first potential is a potential provided to the at least one target emission portion. Providing the electric potential may also be understood as providing a voltage.

In 2830, a second potential may be provided to the focusing electrode. The second potential may be smaller than or equal to the first potential so that the electron beams emitted from the at least one target emission portion may be focused.

The second potential is a potential provided to the focusing electrode.

By providing the first potential to the at least one target emission portion and providing the second potential to the focusing electrode to form an electric field in cooperation with an anode, and providing a corresponding current to each of the at least one target emission portion, each of the at least one target emission portion may independently emit an electron beam so that the target focal point may be formed on a target disk.

In some embodiments, the focusing electrode may include at least two focusing poles, and the at least two focusing poles may be arranged in a one-to-one correspondence with the at least two emission portions. In some embodiments, the second potential may be provided to the focusing pole corresponding to the at least one target emission portion.

For example, when only one emission portion (e.g., the emission portion 211) is operating, the second potential may be provided to the focusing pole (e.g., the focusing pole 221) corresponding to the emission portion. The corresponding second potential may be applied to the focusing electrode corresponding to the target emission portion. Specifically, the focusing electrode may include at least two independent focusing poles, each of which corresponds to an emission portion. By adjusting the potential on each focusing poles, the focusing of the electron beam emitted by the emission portion corresponding to the focusing pole can be controlled respectively, which allows for combined adjustment of the count of the target emission portions or re-determination of the target emission portion, thereby further enhancing the continuity and range of adjustment for the beam spot size, and improving the adaptability of the cathode assembly.

In this embodiment, providing potential only to the operating emission portion(s) and its (their) focusing electrode can improve the flexibility and accuracy of focusing control for the electron beams emitted by the emission portions.

In some embodiments, the cathode assembly may also include an auxiliary electrode, and the auxiliary electrode may be arranged within a fitting hole surrounded by the at least two emission portions. Accordingly, process 2800 may also include an optional operation 2840.

In 2840, a third potential may be provided to the auxiliary electrode.

The third potential is a potential provided to the auxiliary electrode. By combining the auxiliary electrode and the focusing electrode, the focusing of the electron beams may be better achieved and the adaptability of the cathode assembly may be improved.

For example, the second potential provided to the focusing electrode and the third potential provided to the auxiliary electrode may be equal or have a certain potential difference.

Specifically, by applying the third potential to the auxiliary electrode, the auxiliary electrode may cooperate with the focusing poles to control the emission portions corresponding to the focusing poles, thereby further controlling the degree of focusing of the electron beam emitted by each emission portion, and improving the adaptability of the cathode assembly.

There are the following application scenarios when the second and third potentials are equal. If the second potential and the third potential are lower than the first potential of the cathode to a certain extent, the current emission of the cathode may be cut off. When the voltage of the second potential and third potential are gradually increased synchronously, the cathode may start to emit current gradually. When the voltage of the second potential and the third potential is synchronized to increase to a certain value, the cathode reaches a maximum emission current.

Therefore, by controlling the voltage of the second potential and the third potential, an on/off (emitting electrons/stopping emitting electrons) function may be realized for the cathode. For example, referring to FIG. 13, the auxiliary electrode 290 and the focusing pole 222 may be configured to control the on/off state of the emission portion 212, and the auxiliary electrode 290 and focusing pole 223 may be configured to control the on/off state of the emission portion 213, thereby facilitating switching of the beam emission source between the emission portion 212 and the emission portion 213, and achieving short-distance focus deflection of the electron beams in the Y direction. Similarly, the auxiliary electrode 290 and the focusing pole 221 may be configured to control the on/off state of the emission portion 211, and the auxiliary electrode 290 and focusing pole 224 may be configured to control the on/off state of the emission portion 214, thereby facilitating switching of the beam emission source between the emission portion 211 and the emission portion 214, and achieving short-distance focus deflection of the electron beams in the X direction. Furthermore, the auxiliary electrode 290, the focusing pole 222, and the focusing pole 221 may cooperate to control the current emission from the emission portions 212 and 211, and the auxiliary electrode 290, the focusing pole 223, and focusing pole 224 may cooperate to control the current emission from the emission portions 213 and 214. The auxiliary electrode 290, the focusing pole 222, and the focusing pole 224 may cooperate to control the current emission from the emission portions 212 and 214, and the auxiliary electrode 290, the focusing pole 221, and the focusing pole 223 may cooperate to control the current emission from the emission portions 211 and 213, thereby allowing for focus adjustments between two combined cathode sheets.

There are the following application scenarios when there is a certain potential difference between the auxiliary electrode 290 and the focusing pole 222. By changing the potential difference between the auxiliary electrode 290 and the focusing pole 222, the position of the beam spot emitted by the emission portion 212 may be adjusted in the Y direction. When the potential difference between the auxiliary electrode 290 and the focusing pole 222 is periodically altered, the electrons emitted by the emission portion 212 may realize a medium-distance electric focus deflection in the Y direction, and a focus deflection distance may be determined by the magnitude of the potential difference, and the greater the potential difference is, the greater the focus deflection distance may be. When the potential difference between the auxiliary electrode 290 and the focusing pole 222 is fixed, a position of an electron source of the emission portion 212 in the Y-direction may be adjusted in order to change a spot envelope distribution at the focal point when a plurality of cathode sheets emit electron beams.

In addition, the auxiliary electrode 290 and the focusing poles 222-224, having an equal voltage and/or a certain potential difference, may also be used in conjunction to realize regulation of long-distance focus deflection. Taking the focus deflection of the emission portions 212 and 213 in the Y-direction as an example, when the auxiliary electrode 290 and the focusing pole 222 are controlled so that the emission portion 212 does not emit current, and the auxiliary electrode 290 and focusing pole 223 are controlled to make the emission portion 213 emit current, the voltages of the auxiliary electrode 290 and the focusing pole 222 may be the same. However, the voltage of the focusing pole 223 may be adjusted to control the focusing distance of the beam spot emitted by the emission portion 213. Conversely, when the auxiliary electrode 290 and the focusing pole 223 are controlled so that the emission portion 213 does not emit current, and the auxiliary electrode 290 and the focusing pole 222 are controlled to make the emission portion 212 emit current, the voltages of the auxiliary electrode 290 and the focusing pole 223 may be the same. In this case, the voltage of the focusing pole 222 may be adjusted to control the focusing distance of the beam spot emitted by the emission portion 212.

The above embodiments discuss only the control of the auxiliary electrode 290 and the focusing pole 222 for a single emission portion 212, and the cathode control of the emission portions 211-214 is consistent with the above method. Control of combined emission portions may be realized through the combination of corresponding focusing poles. For example, a cathode with a combination of the emission portion 212 and the emission portion 211 may be controlled by a combination of the auxiliary electrode 290, the focusing pole 222, and the focusing pole 221.

The cathode assembly shown in FIG. 13 not only achieves continuous changes from an ultra-small focal point to an ultra-large focal point but also provides a microsecond-level current on/off function, which is of significant importance for reducing patient dosage and balancing doses during multi-energy radiography. Additionally, the technical solution illustrated in FIG. 13 offers faster (e.g., microsecond-level), more precise (e.g., free from eddy current effects), and safer (e.g., a vacuum-scaled structure and less affected by environmental factors) control over the position of the beam spot. Furthermore, its dynamic adjustment capability for the beam spot has reached a higher level: various focus deflection distances can be chosen, with short-distance focus deflection achieved by periodically adjusting the beam spot position, medium-distance focusing achieved by switching the emission portions emitting beams, and long-distance focusing achieved by combining the switching of emission portions with beam spot position adjustment. This ensures that each focusing distance provides fine-tuning for the electron beam, effectively controlling beam control difficulty and beam spot envelope stability at a high level during focusing. The powerful static and dynamic beam spot adjustment capability not only holds immense value for diagnostics but also ensures more efficient utilization of every area of a target material, thereby extending the instrument service life.

In some embodiments, the auxiliary electrode comprises at least two auxiliary poles, and the at least two auxiliary poles are arranged in a one-to-one correspondence with the at least two focusing poles or the at least two emission portions. Similar to the focusing electrode, a third potential may be provided to the auxiliary poles corresponding to the at least two focusing poles or the at least two emission portions.

Subdividing the auxiliary electrodes in this embodiment allows for the provision of an electrical potential for the operating auxiliary pole(s) only, which further improves the flexibility and accuracy of the focusing control of the electron beams emitted by the emission portions.

In some embodiments, after providing the third potential to the auxiliary electrode, the processing device may be further configured to adjust a difference between the second potential of the focusing pole corresponding to the at least one target emission portion and the third potential of the auxiliary electrode, so as to move the electron beam emitted from the at least one target emission portion.

It may be understood that after adjusting the difference between the second potential of the focusing pole corresponding to the at least one target emission portion and the third potential of the auxiliary electrode, the beam spot may move on the target disk. When a count of the at least one target emission portion is one, the beam spot may move in a direction of the arrangement of the auxiliary electrode and the focusing pole corresponding to the target emission portion, thereby enabling adjustment of the position of the target focal point and improving the adaptability of the cathode assembly.

For example, when the count of the target emission portions is one, and the difference between the second potential of the focusing pole corresponding to the target emission portion and the third potential of the auxiliary electrode is adjusted, the position of the beam spot formed by the beam emitted from the target emission portion may be adjusted in a vertical direction. When there is a plurality of target emission portions, the second potential of a plurality focusing poles corresponding to the plurality of target emission portions may be adjusted according to the position of the target focal point to realize the adjustment of the position of the target beam spot.

In some embodiments, after providing the third potential to the auxiliary electrode, the processing device may be further configured to periodically change a difference between the second potential of the focusing pole corresponding to the at least one target emission portion and the third potential of the auxiliary electrode.

For example, when the count of the at least one target emission portion is one, and the difference between the second potential of the focusing pole corresponding to the target emission portion and the third potential of the auxiliary electrode is periodically changed, the position of the beam spot formed by the beam emitted from the target emission portion may be periodically adjusted in the vertical direction to achieve with a short-distance focus deflection in the vertical direction, thereby realizing dynamic adjustment of the position of the beam spot and improve the adaptability of the cathode assembly.

It should be noted that when the count of target emission portions is two or more, the magnitude of the second potential of a plurality of corresponding focusing poles in the target emission portions may be periodically changed to realize the adjusted small-distance focus deflection of the position of the target beam spot.

In the present embodiment, by adjusting the potential difference between the at least two emission portions of the cathode, the focusing electrode, and the auxiliary electrode, the emission and focusing of the electron beam may be realized. In addition, adjusting the potential difference may alter the position of the beam spot, thereby enhancing the flexibility and accuracy for the adjustment of the focusing position of the electron beam.

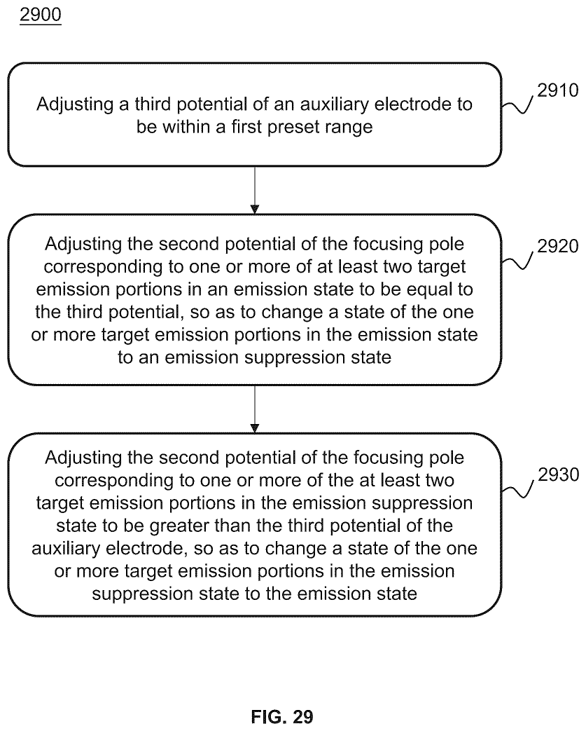

FIG. 29 is a flowchart of an exemplary process for supplying a third potential to an auxiliary electrode according to some embodiments of the present disclosure. In some embodiments, a count of the target emission portions may be at least two, and the operation of providing the third potential to the auxiliary electrode may include process 2900. In some embodiments, process 2900 may be performed by a processing device or an X-ray focus adjustment system. In some embodiments, process 2900 may be performed using the cathode assembly described in the embodiments above. Process 2900 may include the following operations.

In 2910, the third potential may be adjusted to be within a first preset range.

The first preset range refers to the preset potential range for the auxiliary electrode. In some embodiments, the first preset range may be set by a user based on experience. For example, a range of potential of the auxiliary electrode not exceeding a potential at which the emission of the emission portions is cut off may be defined as the first preset range.

In 2920, the second potential of the focusing pole corresponding to one or more of the at least two target emission portions in an emission state may be adjusted to be equal to the third potential, so as to change a state of the one or more target emission portions in the emission state to an emission suppression state.

The emission portion may include an emitting state in which an electron beam is emitted and an emission suppression state in which an electron beam is not emitted. When the third potential and the second potential are equal and both are in the first preset range, the emission of the electron beams of the emission portion is cut off, i.e., the emission portion is in the emission suppression state.

As the third potential of the auxiliary electrode and the second potential of the focusing electrode gradually increase synchronously, the emission portion may gradually start emitting current. When the third potential of the auxiliary electrode and the second potential of the focusing electrode increase to a certain value, the emission portion may emit a maximum emission current, i.e., the emission portion may emit electron beams normally.

In 2930, the second potential of the focusing pole corresponding to one or more of the at least two target emission portions in the emission suppression state may be adjusted to be greater than the third potential of the auxiliary electrode, so as to change a state of the one or more target emission portions in the emission suppression state to the emission state.

When the second potential is greater than the third potential, the emission portion emits electron beams, i.e., the emission portion is in the emission state.

When the third potential of the auxiliary electrode is not equal to the second potential of the focusing electrode, if the second potential of the focusing electrode is greater than the third potential of the auxiliary electrode, the beam spot formed by the beams emitted from the emission portion to the target disk may shift towards the focusing poles; if the second potential of the focusing electrode is smaller than the third potential of the auxiliary electrode, the beam spot formed by the beams emitted from the emission portion to the target disk may shift towards the auxiliary electrode.

In some embodiments, when changing the emission state of a plurality of emission portions, a long-distance focus deflection may be realized. For example, in the X-ray tube in FIG. 13, when there are two target emission portions (e.g., the emission portion 211 and the emission portion 212), the third potential of the auxiliary electrode 290 is in the first preset range, the second potential of the focusing pole 221 is equal to the third potential of the auxiliary electrode 290, and the second potential of the focusing pole 222 is greater than the third potential of the auxiliary electrode 290. At this time, the beam emission of the emission portion 211 is cutoff, i.e., the emission portion 211 is in the emission suppression state, and the emission portion 212 emits an electron beam, i.e., the emission portion 212 is in the emission state. When the second potential of the focusing pole 223 is adjusted to be equal to the third potential of the auxiliary electrode 290, and the second potential of the focusing pole 221 is adjusted to be greater than the third potential of the auxiliary electrode 290, the emission portion 212 does not emit the electron beam, i.e., the emission portion 212 is in the emission suppression state, and the emission portion 211 emits the electron beam, i.e., the emission portion 211 is in the emission state. In this way, switching of electron sources between the emission portion 211 and the emission portion 212 can be achieved, thereby enabling long-distance focus deflectioning in the vertical direction, allowing for long-distance focus deflectioning with minimal changes in beam trajectory, and ensuring safety and stability of the beam.

When there are a plurality of target emission portions, the third potential of the auxiliary electrode may be adjusted to the first preset range, the second potential of the focusing pole corresponding to at least one of the plurality of target emission portions that is in the emmission state may be adjusted to be equal to the third potential of the auxiliary electrode, the second potential of the focusing pole corresponding to at least one of the plurality of target emission portions that is in the emmission suppression state may be adjusted to be greater than the third potential, thereby achieving the switching of multiple electron sources, enhancing the dynamic adjustment range of the beam spot at any position on the target disk, and further improving the adaptability of the cathode assembly.

Furthermore, the two target emission portions may be other combinations as well. For example, by controlling the emission current of the emission portion 212 using the auxiliary electrode and the focusing pole 222, and controlling the emission current of the emission portion 214 using the auxiliary electrode and the focusing pole 224, the switching of electron sources between the emission portions 212 and 214 can be realized. Therefore, the two target emission portions may be any two emission portions, and this embodiment can achieve focus deflectioning between any two emission portions, thus enabling dynamic adjustment of the beam spot at any position on the target disk and further improving the adaptability of the cathode assembly.

In this embodiment, by adjusting the potential difference between the auxiliary electrode and the focusing electrode, the emission state of the emission portions can be regulated. Additionally, by switching the emission states of multiple emission portions, the electron source of the electron beam can be switched, thereby achieving long-distance focus deflection with minimal changes in the beam trajectory, ensuring the safety and stability of the beam. Compared to the conventional technology where the emission portion is cooled by stopping the power supply to switch the electron source emission, this embodiment allows for microsecond-level current switching, which is helpful to reduce patient dose and balance the dose in multi-energy radiotherapy.

It should be noted that in this embodiment, general electronic focus deflection functions can be achieved by periodic changes in the potential difference between the focusing electrode and the auxiliary electrode. Additionally, by controlling the switching of electron beam emission and suppression between two emission portions, a third type of focus deflection, distinct from electronic and magnetic focus deflections, can be realized. Combining periodic changes in the potential difference between the focusing electrode and the auxiliary electrode with electron source emission switching enables long-distance focus deflection while ensuring minimal variation in the electron trajectory of each emission portion, thus better ensuring the safety, stability, and reliability of the beam.

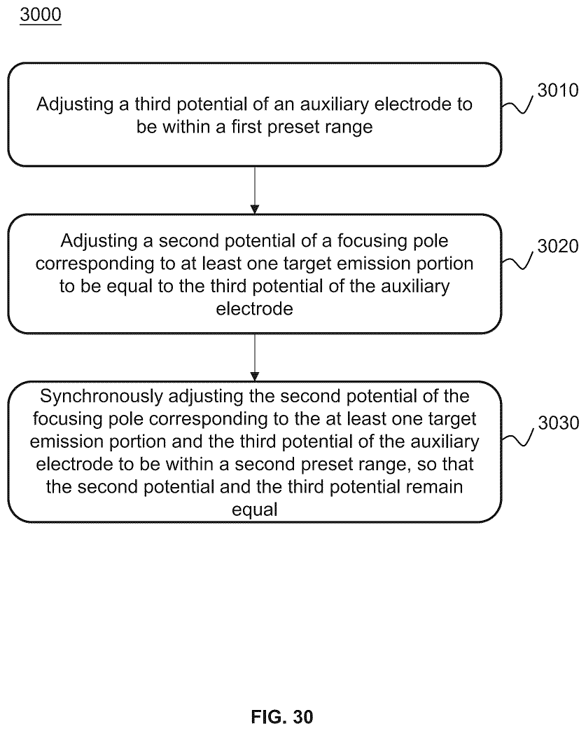

FIG. 30 is a flowchart of an exemplary process for supplying a third potential to an auxiliary electrode according to some embodiments of the present disclosure. In some embodiments, process 3000 may be performed by a processing device or an X-ray focus adjustment system. In some embodiments, process 3000 may be executed using the cathode assembly described in the embodiments above. In some embodiments, process 3000 may include the following operations.

In 3010, the third potential may be adjusted to be within a second preset range.

The second preset range is another preset range of the potential of the auxiliary electrode. In some embodiments, the third potential may be within the second preset range.

In 3020, the second potential of the focusing pole corresponding to the at least one target emission portion may be adjusted to be equal to the third potential of the auxiliary electrode.

By adjusting the second potential of the focusing pole corresponding to one target emission portion to be equal to the third potential of the auxiliary electrode, causing the target emission portion to be in an emission suppression state; and adjusting the second potential of the focusing pole corresponding to another target emission portion to be greater than the third potential, causing the target emission portion to be in an emission state. This ensures that, within the target emission portions, at least one emission portion is in the emission suppression state and at least one emission portion is in the emission state.

In 3030, the second potential of the focusing pole corresponding to the at least one target emission portion and the third potential of the auxiliary electrode may be synchronously adjusted to be within the second preset range, so that the second potential and the third potential remain equal.

When the second potential of the focusing pole corresponding to a target emission portion is equal to the third potential of the auxiliary electrode, the target emission portion may emit a partial electron beam. As the second potential and the third potential increase synchronously, the amount of electron beam emitted by the target emission portion may be adjusted, thereby adjusting the tube current intensity of the target emission portion. Conversely, as the second potential and the third potential decrease synchronously, the tube current may be reduced. It should be noted that the second potential and the third potential remain equal.

In this embodiment, the tube current is precisely controlled in real-time through the focusing electrode and auxiliary electrode, thereby achieving precise and real-time dose adjustment. Additionally, this approach can reduce ineffective doses, balance dual-energy scanning doses, and enable faster dose change rates.

It should be noted that, because the auxiliary electrode and the focusing electrode typically operate in the kilovolt range during normal operation, it may be understood that a difference in potential of a few volts or even tens of volts between the second potential of the focusing pole and the third potential of the auxiliary electrode is considered negligible, and in this case, the second potential of the focusing pole and the third potential of the auxiliary electrode is still considered to be equal.

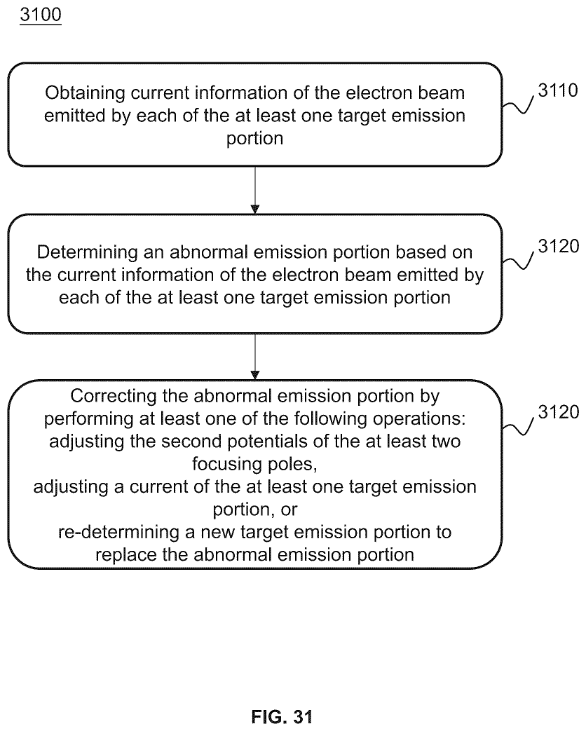

FIG. 31 is a flowchart of an exemplary process for correcting an abnormal transmission portion according to some embodiments of the present disclosure. In some embodiments, process 3100 may be performed by a processing device or an X-ray focus adjustment system. In some embodiments, process 3100 may be executed using the cathode assembly described in the embodiments above. In some embodiments, process 3000 may include the following operations.

In 3110, current information of the electron beam emitted by each of the at least one target emission portion may be obtained.

The current information refers to the magnitude of the current that passes through the emission portion when the electron beam is emitted, which may include the magnitude of the current passed through the current input position and the current output position.

In some embodiments, the current information may be determined by real-time monitoring of the current of the at least one target emission portion.

In 3120, an abnormal emission portion may be determined based on the current information of the electron beam emitted by each of the at least one target emission portion.

An abnormal emission portion refers to an emission portion that has failed or is not operating normally (e.g., unstable). During prolonged high-temperature use of the X-ray tube, abnormal emission portions may occur. It may be possible to determine whether a target emission portion is an abnormal emission portion by determining a change in current in the emission portion or by determining a difference between the actual focal point and a target focal point.

When a target emission portion fails, the size of the target focal point or the tube current changes. Thereby, the specific failed emission portion may be identified. For example, when the value of the current passing through a target emission portion is 0, the target emission portion is an abnormal emission portion.

In 3130, the abnormal emission portion may be corrected by performing at least one of the following operations: adjusting the second potential of the focusing pole corresponding to the abnormal emission portion, adjusting a current of the abnormal emission portion, or re-determining a new target emission portion to replace the abnormal emission portion.

In order to obtain the target focal point, in some embodiments, the abnormal target emission portion may be corrected by adjusting the second potentials of the at least two focusing poles. For example, by adjusting the second potentials of the at least two focusing poles to maintain the remaining emission portions in a same electrical environment as before the failure of the abnormal target emission portion, the remaining emission portions may continue to emit electron beams to obtain the target focal point.

In some embodiments, the abnormal target emission portion may be corrected by adjusting the current of the at least one target emission portion. For example, if the value of the current of the abnormal emission portion is 0, the current of the at least one target emission portion may be adjusted to maintain the state corresponding to the current information before the abnormality. If the current of the abnormal target emission portion is restored to the current of a normal emission portion, the at least one target emission portion may continue to emit electron beams to obtain the target focal point.

In some embodiments, the abnormal target emission portion may be corrected by re-determining a new target emission portion to replace the abnormal emission portion. For example, when a target emission portion is in an irreversible abnormal state, a new emission portion may be selected from the remaining emission portions to serve as the new target emission portion.

After the failure of a target emission portion, the size or current of the target focal point may change. When the tube current changes, the current of the target emission portion may be adjusted. When the size of the beam spot changes, the target emission portion may be re-determined, or the second potential of the focusing pole may be adjusted to achieve the same function and ensure performance continuity. For example, if the emission portion 211 is the target emission portion and its current is found to be 0, the emission portion 211 may not emit an electron beam, causing its failure and resulting in a difference in the spot size on the target disk compared to the target focal point. In this case, a current may be provided to the emission portions 212 and 214 to allow them to emit electron beams, thereby adjusting the beam spot size to achieve the same function and ensure performance continuity.

This embodiment is illustrated using the emission portions 211, 212, and 214 as examples, but it is not limited to these specific emission portions. In other words, the independent control of multiple emission portions described in the present disclosure ensures that even if one emission portion fails, the same function can still be achieved by other emission portions, thereby improving adaptability and reliability.

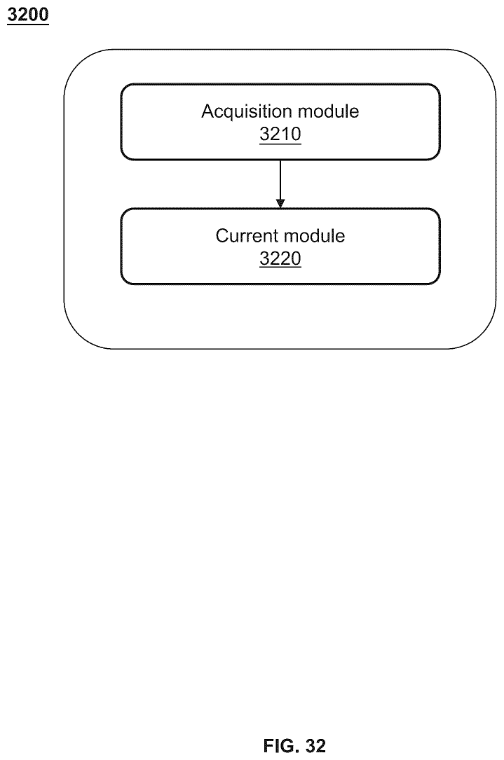

FIG. 32 is a schematic diagram of exemplary modules of a system for adjusting a focal point of an X-ray according to some embodiments of the present disclosure. As shown in FIG. 32, the system 3200 may include an acquisition module 3210, and a current module 3220.

The acquisition module 3210 may be configured to obtain an operating mode of an X-ray tube.

The current module 3220 may be configured to apply a preset current to a cathode according to the operating mode, to selectively control one or more of at least two emission portions of the cathode to be turned on to emit electron beams, wherein the operating mode may include a small focal point mode in which a single emission portion of the at least two emission portions emits the electron beam and a large focal point mode in which two or more emission portions of the at least two emission portions emit the electron beams.

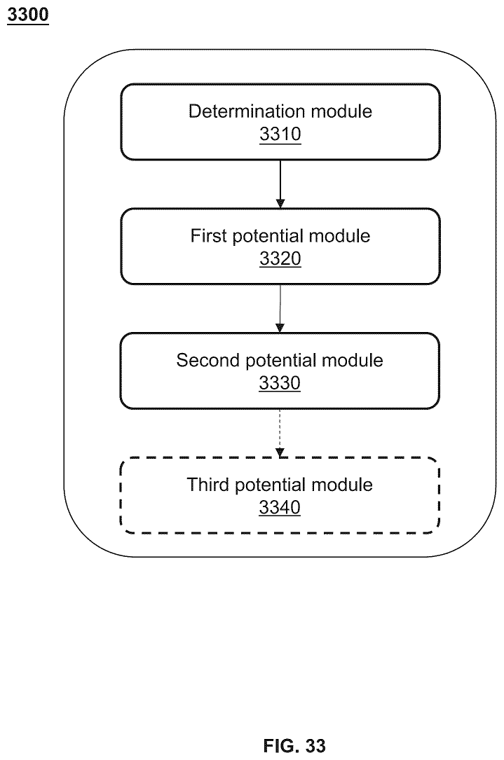

FIG. 33 is a schematic diagram of exemplary modules of a system for controlling a focused electron beam according to some embodiments of the present disclosure. As shown in FIG. 33, the system 3300 may include a determination module 3310, a first potential module 3320, and a second potential module 3330.

The determination module 3310 may be configured to determine at least one target emission portion of a cathode according to a desired position and a desired size of a target focal point.

The first potential module 3320 may be configured to provide a first potential to the at least one target emission portion.

The second potential module 3330 may be configured to provide a second potential to the focusing electrode, wherein the second potential may be less than or equal to the first potential so as to focus the electron beam emitted from the at least one target emission portion.

In some embodiments, the system 3300 may further include a third potential module 3340. The third potential module 3340 may be configured to provide a third potential to an auxiliary electrode.

The cathode assembly, the method for adjusting a focal point of an X-ray, and the method for controlling a focused electron beam described in the present disclosure provide at least the following advantageous effects. (1) Each cathode sheet can independently emit an electron beam, which facilitates the adjustment of the size of the beam spot and the size of the focal point, enhances the adaptability of the cathode assembly to varying focal point size requirements, and enables continuous adjustment from an ultra-small focal point to an ultra-large focal point, thereby providing more focal point choices for clinical applications and allowing for more efficient utilization of each region of the target material. (2) Under different focal point size requirements, the difference in the current passing through each emission portion is small, which is conducive to beam current stability and functional continuity of the cathode sheets, and improves the service life of the cathode sheets. (3) By varying the count of the cathode sheets, the shape of the cathode sheets, as well as the shapes of the focusing poles and cathode sheets, diversified demands of a user can be satisfied. (4) By adjusting the potential difference between the emitting portions of the cathode, the focusing electrode, and the auxiliary electrode, the emission and focusing of the electron beams can be realized, and the adjustment of the potential difference can change the position of the focal point, thereby improve the adaptability of the cathode assembly and satisfying the user's needs for different spot positions. (5) Long-distance focal adjustment can be achieved with minimal changes in beam trajectory, thereby ensuring the safety and stability of the beam and reducing patient radiation dose. (6) The compact arrangement of the emission portions can reduce the volume of the cathode assembly.

The cathode assembly and the corresponding method of adjusting the focal point disclosed in some embodiments of the present disclosure can improve the safety, accuracy, reliability, and stability of X-ray diagnostics. For example, they offer unique advantages in various applications, including but not limited to the followings. (1) In scenarios where focal point size and position adjustments are required, such as in CT or interventional procedures for adjusting resolution or changing focal positions, the disclosed method allows for a wider range of focal spot size and positions, thereby providing faster and more precise adjustments and better integration with other components (e.g., electric field components, magnetic field components). (2) In scenarios where rapid adjustment of X-ray dose or electron current is required, including but not limited to dose reduction and dose balancing in CT or interventional scenarios, the beam brightness may be adjusted faster and more accurately, which is conducive to imaging and the dose safety of the patient. (3) In scenarios where better electron beam distribution is required, including but not limited to CT or interventional scenes, adjusting the electron beam distribution to increase the power and improve the image quality, etc., can obtain a more uniform focal point. (4) In scenarios where the reliability and service life of the cathode assembly need to be improved, including but not limited to compensating for individual failed filaments in CT or interventional scenes, the reliability and service life of the cathode assembly can be significantly improved to ensure the normal operation of the bulb tube and the entire X-ray equipment.

Having thus described the basic concepts, it may be rather apparent to those skilled in the art after reading this detailed disclosure that the foregoing detailed disclosure is intended to be presented as illustrative example and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of the present disclosure.

Moreover, certain terminology has been configured to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

It should be noted that in the foregoing description of embodiments of the present disclosure, various features are sometimes grouped together in a single embodiment, figure, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties configured to describe and claim certain embodiments of the present disclosure are to be understood as being modified in some instances by the term “about,” “approximate,” or “substantially.” For example, “about,” “approximate,” or “substantially” may indicate+20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the count of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A cathode assembly, comprising:
a cathode, including at least two emission portions each of which is configured to independently emit an electron beam, the at least two emission portions being arranged around a center of the cathode; and
a focusing electrode, the focusing electrode being arranged around a periphery of the cathode, a first surface of the focusing electrode forming a first acute angle with an axial direction passing through the center of the cathode.

2. The cathode assembly of claim 1, wherein each of the at least two emission portions includes at least one cathode sheet, an emission surface of the at least one cathode sheet forming a second acute angle with a central axis of the cathode.

3. The cathode assembly of claim 2, further comprising a base, wherein the base includes one or more installation surfaces each of which is configured to allow one or more of the at least one cathode sheet to be installed on the base.

4. The cathode assembly of claim 3, wherein a gap is provided between the cathode and the base, and each of the one or more installation surfaces of the base is parallel to a surface of the cathode sheet installed on the installation surface or forms a third acute angle with the surface of the cathode sheet installed on the installation surface.

5. The cathode assembly of claim 3, wherein each of the at least one cathode sheet is provided with an installation region, the installation region being configured to fix the cathode sheet on the base.

6. The cathode assembly of claim 5, wherein the installation region of each of the at least one cathode sheet is provided with at least one current input position and at least one current output position, and the at least one current input position and the at least one current output position are configured to control electron beam emission of the cathode sheet.

7. The cathode assembly of claim 2, wherein shapes of the cathode sheets of the at least two emission portions are the same, sizes of the cathode sheets of the at least two emission portions are equal, and the cathode sheets of the at least two emission portions are uniformly arranged along a circumferential direction of the cathode.

8. The cathode assembly of claim 6, wherein angles between each of the cathode sheets of the at least two emission portions and the central axis of the cathode are equal.

9. The cathode assembly of claim 2, wherein a gap is provided between the cathode sheets of the at least two emission portions.

10. The cathode assembly of claim 2, wherein the second acute angle is in a range of 45°≤θ1≤86°.

11. The cathode assembly of claim 1, wherein the focusing electrode includes at least two focusing poles, the at least two focusing poles being arranged in a one-to-one correspondence with the at least two emission portions.

12. The cathode assembly of claim 10, further comprising an auxiliary electrode, the auxiliary electrode being arranged within a fitting hole surrounded by the at least two emission portions.

13. The cathode assembly of claim 1, wherein adjacent edges of any two adjacent emission portions of the at least two emission portions are parallel.

14. A method for adjusting a focal point of an X-ray using a cathode assembly, wherein
the cathode assembly comprises:
a cathode, including at least two emission portions each of which is configured to independently emit an electron beam, the at least two emission portions being arranged around a center of the cathode; and
a focusing electrode, the focusing electrode being arranged around a periphery of the cathode, a first surface of the focusing electrode forming a first acute angle with an axial direction passing through the center of the cathode;
the method comprises:
obtaining an operating mode of an X-ray tube;
applying a preset current to the cathode according to the operating mode, to selectively control one or more of the at least two emission portions of the cathode to emit the electron beams.

15. A method for controlling a focused electron beam using a cathode assembly, wherein
the cathode assembly comprises:
a cathode, including at least two emission portions each of which is configured to independently emit an electron beam, the at least two emission portions being arranged around a center of the cathode; and
a focusing electrode, the focusing electrode being arranged around a periphery of the cathode, a first surface of the focusing electrode forming a first acute angle with an axial direction passing through the center of the cathode;
the method comprises:
determining at least one target emission portion of the cathode according to a desired position and a desired size of a target focal point;
providing a first potential to the at least one target emission portion; and
providing a second potential to the focusing electrode, so as to focus the electron beam emitted from the at least one target emission portion.

16. The method of claim 14, wherein the focusing electrode includes at least two focusing poles, the at least two focusing poles being arranged in a one-to-one correspondence with the at least two emission portions, and the providing a second potential to the focusing electrode includes:
providing the second potential to the focusing pole corresponding to the at least one target emission portion.

17. The method of claim 14, wherein the cathode assembly further includes an auxiliary electrode, the auxiliary electrode being arranged within a fitting hole surrounded by the at least two emission portions, the method further comprising:
providing a third potential to the auxiliary electrode.

18. The method of claim 17, wherein after providing a third potential to the auxiliary electrode, the method further comprises:
adjusting a difference between the second potential of the focusing pole corresponding to the at least one target emission portion and the third potential of the auxiliary electrode, so as to move the electron beam emitted from the at least one target emission portion.

19. The method of claim 17, wherein after providing a third potential to the auxiliary electrode, the method further comprises:
periodically changing a difference between the second potential of the focusing pole corresponding to the at least one target emission portion and the third potential of the auxiliary electrode.

20. The method of claim 17, further comprising:
adjusting a third potential to be within a first preset range;
adjusting the second potential of the focusing pole corresponding to one or more of the at least two target emission portions in an emission state to be equal to the third potential, so as to change a state of the one or more target emission portions in the emission state to an emission suppression state; or
adjusting the second potential of the focusing pole corresponding to one or more of the at least two target emission portions in the emission suppression state to be greater than the third potential of an auxiliary electrode, so as to change a state of the one or more target emission portions in the emission suppression state to the emission state.
